(19) United States
(12) Patent Application Publication
(10) Pub. No.: US 2026/0205986 A1
(43) Pub. Date: Jul. 16, 2026

(54) Termination of Positioning in a Communication Network

(71) Applicant: Telefonaktiebolaget LM Ericsson (publ), Stockholm (SE)

(72) Inventors: Thomas Johansson, Åby (SE); Mohammed Yazid Lyazidi, London (GB)

(21) Appl. No.: 19/135,507

(22) PCT Filed: Dec. 7, 2023
(86) PCT No.: PCT/SE2023/051232

§ 371 Date: Jun. 4, 2025

Related U.S. Application Data
(60) Provisional application No. 63/386,494, filed on Dec. 7, 2022.

(51) Int. Cl. H04W 64/00; H04L 5/00

(52) U.S. Cl. CPC H04W 64/00; H04L 5/0051

(57) ABSTRACT

A location server (14) is configured for use in a communication network (10). The location server (14) receives, from a radio network node (18), as part of a Positioning Information Update procedure, a message (16-2U) indicating that sounding reference signaling, SRS, transmission from a specific communication device (12) has stopped. Based on the message in some embodiments, the location server (14) transmits signaling that requests, commands, or triggers termination or deactivation of positioning measurements in one or more transmission reception points (20-1, 20-2 . . . 20-N) at which positioning measurements have started for the specific communication device (12).

### TECHNICAL FIELD

The present application relates generally to a communication network, and relates more particularly to termination of positioning in such a network.

### BACKGROUND

A location server for a communication network may request a radio network node to provide positioning information to the location server, including information about how to configure positioning measurements for determining the position of a communication device. The location server may thereafter request the radio network node to report the positioning measurements for determining the position of the communication device. If the positioning measurements are ongoing, the location server may request that the radio network node periodically provide the positioning information and/or positioning measurements, e.g., as changes occur in the positioning information or as positioning measurements are performed. The distributed nature of functionality needed for location services between the radio network node and the location server provides efficiencies in centralizing positioning determination in the location server and simplification of the radio network node. However, the distributed nature nonetheless introduces challenges where the radio network node initially complies with the location server's request for positioning information or positioning measurements, but changing circumstances later frustrate the radio network node's ability to continue complying.

### SUMMARY

Some embodiments herein introduce messaging for a radio network node to notify a location server that positioning information for a specific communication device is no longer valid and/or that the radio network node can no longer report any updates to the positioning information, e.g., with the indicated reason being that the specific communication device has lost its connection. The messaging may for example be based on device-associated signaling, e.g., that employs a device-associated connection for conveying the messaging. By notifying the location server of this for a specific communication device, the location server is able to trigger termination of positioning for the specific communication device in a way that is more efficient than if the messaging had not conveyed for which communication device the positioning information has become invalid. Indeed, rather than having to perform correlation or other processing to deduce for which specific communication device positioning should be terminated, as would otherwise be required without device-associated signaling, the messaging itself conveys this information to the location server.

More particularly, embodiments herein include a method performed by a location server configured for use in a communication network. The method comprises receiving, from a radio network node, as part of a Positioning Information Update procedure, a message indicating that sounding reference signaling, SRS, transmission from a specific communication device has stopped.

In some embodiments, the method further comprises, based on the message, determining that an SRS configuration previously received from the radio network node for the specific communication device is invalid and/or that reporting of any updates to an SRS configuration for the specific communication device has been terminated by the radio network node.

In some embodiments, the method further comprises, based on the message, transmitting signaling that requests, commands, or triggers one or more transmission reception points to stop or abort one or more positioning measurements for the specific communication device. In other embodiments, the method further comprises, based on the message, transmitting signaling that requests, commands, or triggers termination or deactivation of positioning measurements in one or more transmission reception points at which positioning measurements have started for the specific communication device.

In some embodiments, the method further comprises, based on the message, determining one or more transmission reception points at which one or more positioning measurements have been started for the specific communication device and transmitting signaling that requests, commands, or triggers the one or more transmission reception points to abort or deactivate the one or more positioning measurements for the specific communication device. In other embodiments, the method further comprises, based on the message, alternatively or additionally determining one or more transmission reception points at which resources have been allocated for positioning of the specific communication device and transmitting signaling that requests, commands, or triggers the one or more transmission reception points to release or deactivate resources that have been allocated for positioning of the specific communication device.

In some embodiments, the message is a POSITIONING INFORMATION UPDATE message.

In some embodiments, the Positioning Information Update procedure is a procedure initiated by the radio network node to indicate to the location server that a change has occurred in an SRS configuration for the specific communication device, and the message lacks any update to the SRS configuration for the specific communication device.

In some embodiments, the message is received via device-associated signaling that is associated with the specific communication device. In other embodiments, the message is received over a device-associated signaling connection that is associated with the specific communication device.

In some embodiments, the method further comprises determining the specific communication device for which the message is received, based on the specific communication device being associated with device-associated signaling or a device-associated signaling connection via which the message is received. In some embodiments, determining the specific communication device is performed without searching, across multiple transmission reception points associated with the radio network node, for a match between an SRS configuration for a device context and an SRS configuration for a measurement context. In other embodiments, determining the specific communication device is performed without searching, across multiple transmission reception points associated with the radio network node, for a match between a measurement identifier in a device context and a measurement identifier in a measurement context.

In some embodiments, the location server implements a location management function, LMF. In some embodiments, the radio network node is a gNodeB, and wherein the message is received via a New Radio, NR, Positioning Protocol, NRPPa.

Other embodiments herein include a method performed by a radio network node configured for use in a communication network. The method comprises transmitting, from the radio network node to a location server, as part of a Positioning Information Update procedure, a message indicating that sounding reference signaling, SRS, transmission from a specific communication device has stopped.

In some embodiments, the message is a POSITIONING INFORMATION UPDATE message.

In some embodiments, the Positioning Information Update procedure is a procedure initiated by the radio network node to indicate to the location server that a change has occurred in an SRS configuration for the specific communication device, and the message lacks any update to the SRS configuration for the specific communication device.

In some embodiments, the message is transmitted via device-associated signaling that is associated with the specific communication device. In other embodiments, the message is transmitted over a device-associated signaling connection that is associated with the specific communication device.

In some embodiments, the location server implements a location management function, LMF. In some embodiments, the radio network node is a gNodeB, and wherein the message is transmitted via a New Radio, NR, Positioning Protocol, NRPPa.

Other embodiments herein include a location server configured for use in a communication network. The location server is configured to receive, from a radio network node, as part of a Positioning Information Update procedure, a message indicating that sounding reference signaling, SRS, transmission from a specific communication device has stopped.

In some embodiments, the location server is configured to perform the steps described above for a location server configured for use in a communication network.

Other embodiments herein include a radio network node configured for use in a communication network. The radio network node is configured to transmit, from the radio network node to a location server, as part of a Positioning Information Update procedure, a message indicating that sounding reference signaling, SRS, transmission from a specific communication device has stopped.

In some embodiments, the radio network node is configured to perform the steps described above for a radio network node configured for use in a communication network.

In some embodiments, a computer program comprising instructions which, when executed by at least one processor of a location server, causes the location server to perform the steps described above for a location server configured for use in a communication network. In some embodiments, a computer program comprising instructions which, when executed by at least one processor of a radio network node, causes the radio network node to perform the steps described above for a radio network node configured for use in a communication network. In some embodiments, a carrier containing the computer program is one of an electronic signal, optical signal, radio signal, or computer readable storage medium.

Other embodiments herein include a location server configured for use in a communication network. The location server comprises communication circuitry and processing circuitry. The processing circuitry is configured to receive, from a radio network node, as part of a Positioning Information Update procedure, a message indicating that sounding reference signaling, SRS, transmission from a specific communication device has stopped.

In some embodiments, the processing circuitry is configured to perform the steps described above for a location server configured for use in a communication network.

Other embodiments herein include a radio network node configured for use in a communication network. The radio network node comprises communication circuitry and processing circuitry. The processing circuitry is configured to transmit, from the radio network node to a location server, as part of a Positioning Information Update procedure, a message indicating that sounding reference signaling, SRS, transmission from a specific communication device has stopped.

In some embodiments, the processing circuitry is configured to perform the steps described above for a radio network node configured for use in a communication network.

Embodiments herein also include a method performed by a location server configured for use in a communication network. The method comprises receiving, from a radio network node in the communication network, a first message that provides positioning information for a specific communication device. The method also comprises after receiving the first message, receiving, from the radio network node, a second message notifying the location server that the positioning information for the specific communication device is no longer valid and/or that the radio network node can no longer report any updates to the positioning information for the specific communication device.

Still other embodiments herein include a method performed by a radio network node configured for use in a communication network. The method comprises transmitting, to a location server in the communication network, a first message that provides positioning information for a specific communication device. The method also comprises, after transmitting the first message, transmitting, to the location server, a second message notifying the location server that the positioning information for the specific communication device is no longer valid and/or that the radio network node can no longer report any updates to the positioning information for the specific communication device.

Yet other embodiments herein include a method performed by a location server configured for use in a communication network. The method comprises receiving, from a radio network node in the communication network, a first message that indicates the radio network node is able to initiate positioning measurements. The method also comprises, after receiving the first message, receiving, from the radio network node, a second message notifying the location server that the radio network node can no longer report the positioning measurements.

Further embodiments herein include a method performed by a radio network node configured for use in a communication network. The method comprises transmitting, to a location server in the communication network, a first message that indicates the radio network node is able to initiate positioning measurements. The method also comprises, after transmitting the first message, transmitting, to the location server, a second message notifying the location server that the radio network node can no longer report the positioning measurements.

Embodiments herein include corresponding apparatus, computer programs, and carriers of those computer programs.

### BRIEF DESCRIPTION OF THE DRAWINGS

FIG. 1 is a block diagram of a communication network according to some embodiments.

FIG. 2 is a block diagram of a communication network according to other embodiments.

FIG. 3 is a block diagram of a New Radio (NR) Positioning architecture according to some embodiments.

FIG. 4 is a call flow diagram of a multi-RTT positioning method according to some embodiments.

FIG. 5 is a call flow diagram of successful operation of a Positioning Information Exchange procedure according to some embodiments.

FIG. 6 is a call flow diagram of successful operation of a Measurement procedure according to some embodiments.

FIG. 7 is a call flow diagram of a procedure for a non-UE associated MEASUREMENT ABORT message according to some embodiments.

FIG. 8 is a call flow diagram of successful operation of a Positioning Deactivation procedure according to some embodiments.

FIG. 9 is a call flow diagram of a procedure for a non-UE associated MEASUREMENT FAILURE INDICATION message according to some embodiments.

FIG. 10 is a call flow diagram of successful operation of a Positioning Information Failure Indication procedure according to some embodiments.

FIG. 11 is a logic flow diagram of a method performed by a location server configured for use in a communication network in accordance with particular embodiments.

FIG. 12 is a logic flow diagram of a method performed by a radio network node configured for use in a communication network in accordance with particular embodiments.

FIG. 13 is a logic flow diagram of a method performed by a location server configured for use in a communication network in accordance with other embodiments.

FIG. 14 is a logic flow diagram of a method performed by a radio network node configured for use in a communication network in accordance with other embodiments.

FIG. 15 is a block diagram of a radio network node configured for use in a communication network in accordance with particular embodiments.

FIG. 16 is a block diagram of a location server configured for use in a communication network in accordance with particular embodiments.

FIG. 17 shows an example of a communication system in accordance with some embodiments.

FIG. 18 is a block diagram of a host which may be an embodiment of the host 1716 of FIG. 17, in accordance with various aspects described herein.

### DETAILED DESCRIPTION

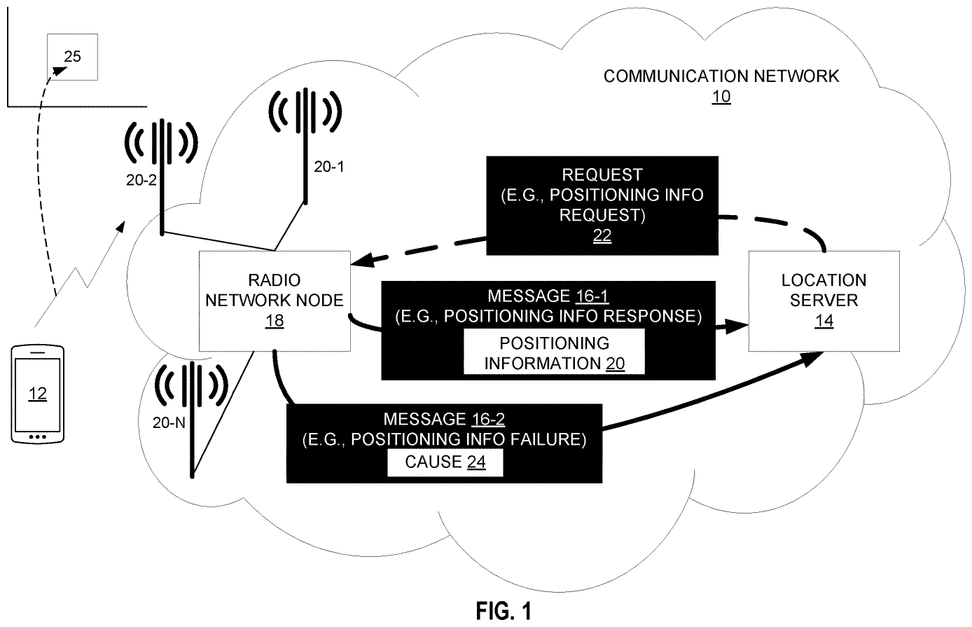

FIG. 1 shows a communication network 10 configured to provide communication service to a communication device 12 according to some embodiments. The communication network 10 may for example include transmission reception points (TRPs) 20-1, 20-2, . . . 20-N in an access network, to provide access to the communication network 10.

As shown, the communication network 10 includes a location server 14 configured to support positioning of the communication device 12, i.e., determination of a position of the communication device 12. In embodiments where the communication network 10 is a 5G network, for example, the location server 14 is configured to implement a location management function (LMF).

The location server 14 as shown receives a first message 16-1 from a radio network node 18 in the communication network 10, e.g., an NG-RAN node that may be associated with one or more TRPs 20-1, 20-2, . . . 20-N. The first message 16-1 provides positioning information 20 for a specific communication device 12. In one embodiment, the first message 16-1 is a response to a request 22 that the location server 14 transmitted to the radio network node 18, e.g., a positioning information request that requests the positioning information 20 for the specific communication device 12. In one example of this, the request 22 may be a POSITIONING INFORMATION REQUEST message and the first message 16-1 may be a POSITIONING INFORMATION RESPONSE message.

The positioning information 22 in some embodiments is information for configuring positioning of the specific communication device 12, configuring positioning measurements for positioning of the specific communication device 12, and/or configuring resources 25 on which are to be performed positioning measurements for positioning of the specific communication device 12. As described more fully later, the positioning information 22 may for example include a sounding reference signal (SRS) configuration for the specific communication device 12, a System Frame Number (SFN) initialization time, and/or a UE Tx timing error group (TEG) Association List.

In some embodiments, the radio network node's sending of this first message 16-1 confirms that the radio network node 18 is able to provide the positioning information 20 to the location server 14 and that the provided positioning information 20 is valid. The validity of the positioning information 20 may for example mean that the positioning information 20 is usable for positioning of the specific communication device 12. Where the positioning information 20 indicates an SRS configuration for the specific communication device 12, for example, the validity of the positioning information 20 may mean that SRS resources configured by the SRS configuration are in fact allocated to the specific communication device 12 (e.g., the specific communication device 12 has not been released by the radio network node 18 along with its SRS resources) and that SRS from the specific communication device 12 is receivable on those SRS resources. Regardless, in some embodiments, such as where the request 22 requests the positioning information 20 on a periodic or otherwise ongoing basis in order to track any change or update to that positioning information 20, the radio network node's sending of the first message 16-1 may implicitly confirm that the radio network node 18 is able to report any updates to the positioning information 20 for the specific communication device 12. In fact, after receiving the first message 16-1, the location server 14 may transmit signaling (not shown) to start positioning measurements in one or more TRPs 20-1, 20-2, . . . 20-N. The signaling in this case may indicate resources on which to perform the positioning measurements, e.g., SRS resources consistent with the SRS configuration in the positioning information 20.

At some point after receiving the first message 16-1 with this positioning information 20, though, the location server 14 later receives a second message 16-2, e.g., during ongoing positioning of the specific communication device 12. This second message 16-2 notifies the location server 14 that the positioning information 20 for the specific communication device 12 is no longer valid and/or that the radio network node 18 can no longer report any updates to the positioning information 20 for the specific communication device 12. The second message 16-2 may for example be a POSITIONING INFORMATION FAILURE message or a POSITIONING INFORMATION FAILURE INDICATION message, e.g., as part of a Positioning Information Exchange class 2 failure indication procedure. Or, the second message 16-2 may be a POSITIONING INFORMATION UPDATE message, e.g., as part of a Positioning Information Update procedure. But, in this case, rather than notifying the location server 14 of a change in the positioning information 20 and providing the location server 14 with updated positioning information, the POSITIONING INFORMATION UPDATE message in this case lacks any update to the positioning information 20 (since there is no update).

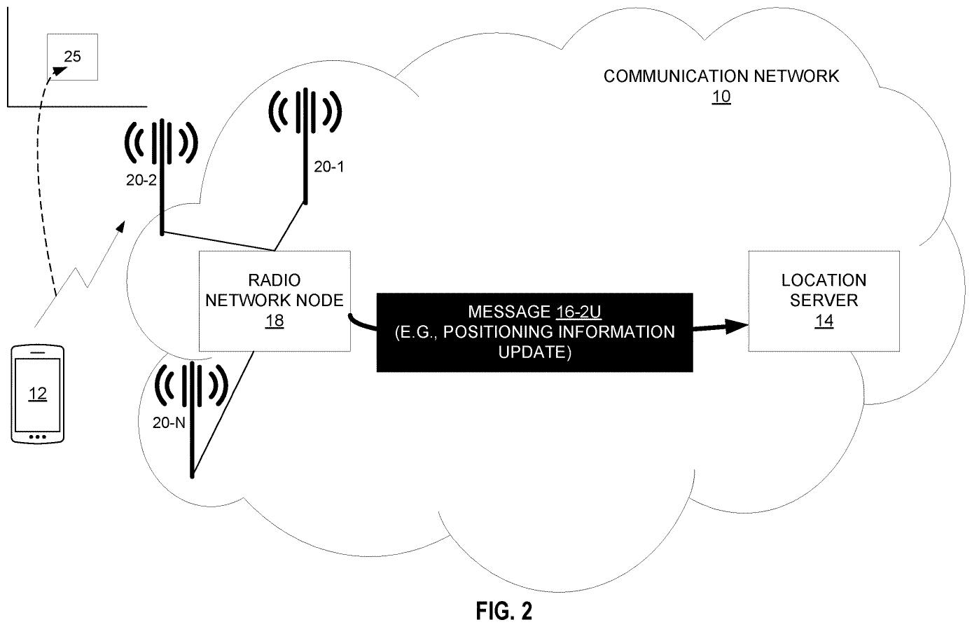

FIG. 2 for example shows one embodiment where the second message 16-2 is a message 16-2U that is a part of a Positioning Information Update procedure. The second message 16-2U in this case may be a POSITIONING INFORMATION UPDATE message. Regardless, in some embodiments, the second message 16-2U indicates that SRS transmission from the specific communication device 12 has stopped, i.e., that SRS has stopped being sent from the specific communication device 12. The second message 16-2U may indicate this even though the Positioning Information Update procedure is a procedure initiated by the radio network node 18 to indicate to the location server 14 that a change has occurred in an SRS configuration for the specific communication device 12. In some embodiments in this regard, the second message 16-2U lacks any update to the SRS configuration for the specific communication device 12.

In some embodiments, the second message 16-2 includes a cause 24 (e.g., a radio network layer cause) indicating a reason why the positioning information 20 for the specific communication device 12 is no longer valid and/or why the radio network node 18 can no longer report any updates to the positioning information 20 for the specific communication device 12. In one embodiment, the cause 24 is that a connection with the specific communication device 12 has been terminated, has been lost, or has timed out, or that the specific communication device 12 has lost coverage. In another embodiment, the cause 24 is that a context of the specific communication device 12 has been released, has been released in association with a mobility of the specific communication device 12, or has been released in association with a release of the specific communication device 12. In yet another embodiment, the cause 24 is failure by the specific communication device 12 to send SRS, that SRS is not or cannot be sent by the specific communication device 12, or that the specific communication device 12 has stopped sending SRS. In still another embodiment, the cause 24 is the specific communication device 12 being released, disappearing, or experiencing an error. In any of these embodiments, the second message 16-2 may include a cause field whose value indicates the cause 24 and whose value is selected from among multiple possible values that are mapped to different possible causes, e.g., where the different possible causes may include one or more of the causes exemplified above.

Via the cause 24 or otherwise, the second message 16-2 may effectively differentiate the issue as being fatal to positioning of the specific communication device 12. Rather than the issue being failure of one of potentially multiple transmission reception points (TRPs) 20-1, 20-2 . . . 20-N associated with the radio network node 18 being able to perform positioning measurements, in which case positioning can continue albeit with less measurements, the second message 16-2 suggests that positioning of the specific communication device 12 cannot continue at all. Indeed, if the specific communication device 12 has been released or is otherwise not transmitting signals on which positioning measurements can be performed, no positioning can take place at all.

Accordingly, in some embodiments, based on the second message 16-2, the location server 14 considers the positioning information 20 for the specific communication device 12 to be invalid and/or considers that reporting of any updates to the positioning information 20 for the specific communication device 12 has been terminated by the radio network node 18. In this latter case, for example, the location server 14 may determine that the radio network node 18 has terminated reporting of any updates to the positioning information 20 for the specific communication device 12. Where the positioning information 20 includes an SRS configuration, for example, the location server 14 may determine that an SRS configuration previously received from the radio network node 18 for the specific communication device 12 is invalid and/or that reporting of any updates to an SRS configuration for the specific communication device 12 has been terminated by the radio network node 18.

In these and other embodiments, then, based on the second message 16-2, the location server 14 may accordingly transmit signaling (not shown) that requests, commands, or triggers one or more TRPs 20-1, 20-2, . . . 20-N to stop or abort one or more positioning measurements for the specific communication device 12. Or the location server 14 may transmit signaling (not shown) that requests, commands, or triggers termination or deactivation of positioning measurements in one or more TRPs 20-1, 20-2, . . . 20-N at which positioning measurements have started for the specific communication device 12.

In some embodiments, the location server 14 determines the TRP(s) 20-1, 20-2, . . . 20-N for which to control positioning measurements in this way on the basis of the identifying the specific communication device 12 to which the second message 16-2 relates. For example, based on the second message 16-2 being for the specific communication device 12, the location server 14 may determine one or more TRPs 20-1, 20-2, . . . 20-N at which positioning measurement(s) have been started for the specific communication device 12 and then transmit signaling that requests, commands, or triggers the one or more TRPs 20-1, 20-2, . . . 20-N to abort or deactivate the positioning measurement (2) for the specific communication device 12. Or, as another example, the location server 14 may determine, based on the second message 16-2 being for the specific communication device 12, one or more TRPs 20-1, 20-2, . . . 20-N at which resources have been allocated for positioning of the specific communication device 12 and then transmit signaling that requests, commands, or triggers the one or more TRPs 20-1, 20-2, . . . 20-N to release or deactivate resources that have been allocated for positioning of the specific communication device 12.

To support this, the notification that the second message 16-2 provides to the location server 14 is notably specific to the specific communication device 12, rather than being generic for just any communication device. In some embodiments, for example, the location server 14 receives the second message 16-2 via device-associated signaling, e.g., that employs a device-associated connection for conveying the message 16-2. In this case, then, even if the second message 16-2 does not itself include an identity of the specific communication device 12, the location server 14 associates the second message 16-2 with the specific communication device 12 because the connection over which the message 16-2 is received is associated with the specific communication device 12. By notifying the location server 14 of this for the specific communication device 12, the location server 14 is able to trigger termination of positioning for the specific communication device 14 in a way that is more efficient than if the second message 16-2 had not somehow conveyed for which communication device the positioning information 20 has become invalid or conveyed for which communication device the radio network node 18 can no longer report updated positioning information. Indeed, rather than having to perform correlation or other processing to deduce for which specific communication device positioning should be terminated, as would otherwise be required without device-associated signaling, the second message 16-2 itself conveys this information to the location server 14 (e.g., by way of being received over a device-associated connection). In some embodiments, then, the location server 14 determines the specific communication device 12 without having to search, across multiple TRPs associated with the radio network node 18, for a match between an SRS configuration for a device context and an SRS configuration for a measurement context. Similarly, the location server 14 determines the specific communication device 12 without having to search, across multiple TRPS associated with the radio network node 18, for a match between a measurement identifier in a device context and a measurement identifier in a measurement context.

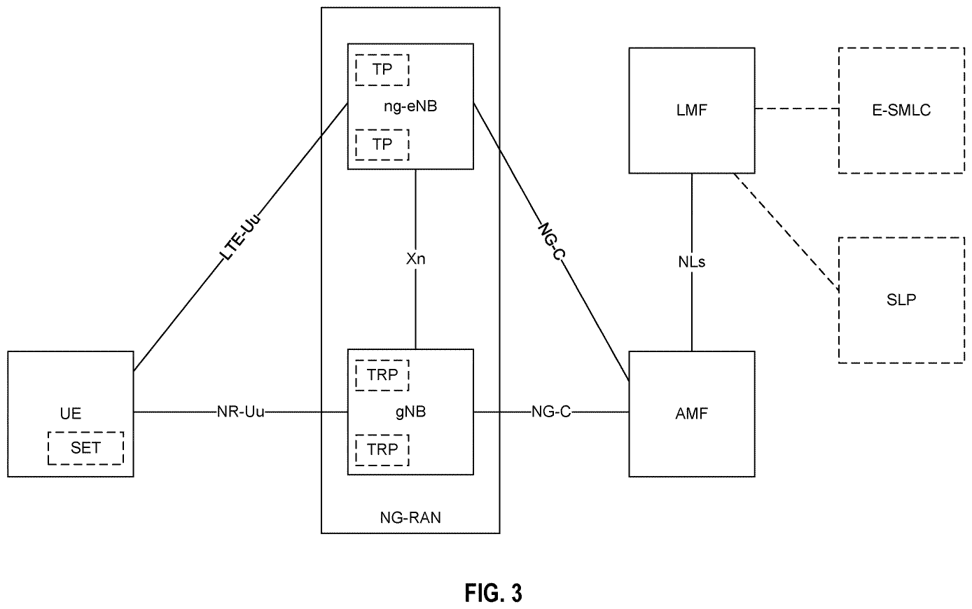

Consider now some example embodiments where the first message 16-1 and/or the second message 16-2 in FIG. 1 is communicated using a Positioning Protocol between the location server 14 and the radio network node 18, e.g., a New Radio Positioning Protocol (NRPPa). FIG. 3 in this regard shows the NR Positioning architecture (as per TS 38.305 v17.2.0). The specific communication device 12 in this case may be exemplified as a specific user equipment (UE), the location server 14 may be exemplified by an LMF, and the radio network node 18 may be exemplified as an NG-RAN node (e.g., a gNodeB).

The Access and Mobility Function (AMF) receives a request for some location service associated with a particular target UE from another entity (e.g., Gateway Mobile Location Center, GMLC, or UE) or the AMF itself decides to initiate some location service on behalf of a particular target UE (e.g., for an Internet Protocol, IP, Multimedia Subsystem, IMS, emergency call from the UE) as described in TS 23.502 v17.10.0 and TS 23.273 v17.6.0. The AMF then sends a location services request to an LMF. The LMF processes the location services request which may include transferring assistance data to the target UE to assist with UE-based and/or UE-assisted positioning and/or may include positioning of the target UE. The LMF then returns the result of the location service back to the AMF (e.g., a position estimate for the UE). In the case of a location service requested by an entity other than the AMF (e.g., a GMLC or UE), the AMF returns the location service result to this entity. Long Term Evolution (LTE) Positioning Protocol (LPP) is the point-to-point communication protocol between an LMF and a device. New Radio (NR) Positioning Protocol a (NRPPa) is the communication protocol between an gNB and LMF.

An NG-RAN node may control several TRPs/transmission points (TPs), such as remote radio heads, or downlink-Positioning Reference Signal only (DL-PRS-only) TPs for support of PRS-based Terrestrial Beacon System (TBS) positioning. Here, PRS stands for positioning reference signal.

Some embodiments herein are applicable for positioning using a multi-RTT positioning method, where RTT stands for round trip time.

The multi-RTT positioning method involves both UE measurements and gNB measurements. Both UE and gNB measurements require downlink (DL) PRS and uplink (UL) SRS. The UE shall measure the time difference between reception of PRS and transmission of SRS. The gNB shall measure the time difference between reception of SRS and transmission of PRS.

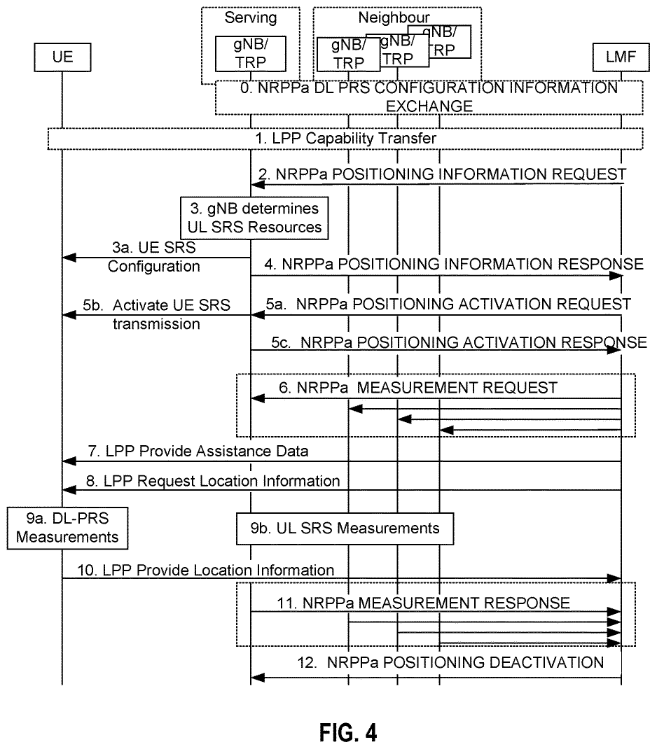

FIG. 4 shows one embodiment of the multi-RTT positioning method. In particular, FIG. 4 shows the messaging between the LMF, the gNBs and the UE to perform LMF-initiated Location Information Transfer Procedure for Multi-RTT.
0. The LMF may use a procedure to obtain the TRP information required for Multi-RTT positioning.
1. The LMF may request the positioning capabilities of the target device using the LPP Capability Transfer procedure.
2. The LMF sends a NRPPa POSITIONING INFORMATION REQUEST message to the serving gNB to request UL information for the target device, where this UL information exemplifies the positioning information 20 in FIG. 1 and where the NRPPa POSITIONING INFORMATION REQUEST message exemplifies the request 22 in FIG. 1.
3. The serving gNB determines the resources available for UL-SRS and configures the target device with the UL-SRS resource sets at step 3a.
4. The serving gNB provides the UL-SRS configuration information to the LMF in a NRPPa POSITIONING INFORMATION RESPONSE message. This UL-SRS configuration information exemplifies the positioning information 20 in FIG. 1 and the NRPPa POSITIONING INFORMATION RESPONSE message exemplifies the first message 16-1 in FIG. 1.
5. In the case of semi-persistent or aperiodic SRS, the LMF may request activation of UE SRS transmission by sending a NRPPa Positioning Activation Request message to the serving gNB of the target device. The gNB then activates the UE SRS transmission and sends a NRPPa Positioning Activation Response message. The target device begins the UL-SRS transmission according to the time domain behavior of UL-SRS resource configuration.
6. The LMF provides the UL information to the selected gNBs in a NRPPa MEASUREMENT REQUEST message. The message includes all information required to enable the gNBs/TRPs to perform the UL measurements.
7. The LMF sends a LPP Provide Assistance Data message to the target device. The message includes any required assistance data for the target device to perform the necessary DL-PRS measurements.
8. The LMF sends a LPP Request Location Information message to request Multi-RTT measurements.
9a: The target device performs the DL-PRS measurements from all gNBs provided in the assistance data at step 7.
9b: Each gNB configured at step 6 measures the UE SRS transmissions from the target device.
10. The target device reports the DL-PRS measurements for Multi-RTT to the LMF in a LPP Provide Location Information message.
11. Each gNB reports the UE SRS measurements to the LMF in a NRPPa Measurement Response message.
12. The LMF sends a NRPPa POSITIONING DEACTIVATION message to the serving gNB.
13. The LMF determines the RTTs from the UE and gNB Rx-Tx time difference measurements for each gNB for which corresponding UL and DL measurements were provided at steps 10 and 11 and calculates the position of the target device.

In this example, the second message 16-2 (e.g., in the form of a POSITIONING INFORMATION FAILURE INDICATION message) may be sent any time after step 4 if periodic SRS or after 5c for a-periodic or semi-persistent SRS.

Positioning may therefore involve several procedures. One of the procedures is that LMF requests allocation of SRS resources from the gNB. In particular, the Positioning Information Exchange procedure is initiated by the LMF to request to the NG-RAN node positioning information for the UE. This procedure applies only if the NG-RAN node is a gNB.

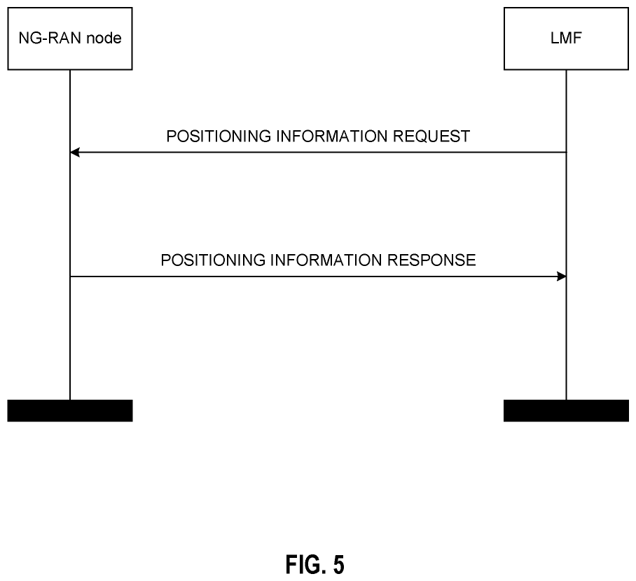

FIG. 5 shows successful operation of the Positioning Information Exchange procedure according to some embodiments.

The LMF initiates the procedure by sending a POSITIONING INFORMATION REQUEST message to the NG-RAN node.

If the Requested SRS Transmission Characteristics information element (IE) is included in the POSITIONING INFORMATION REQUEST message, the NG-RAN node may take this information into account when configuring SRS transmissions for the UE, and it shall include the SRS Configuration IE and the System Frame Number (SFN) Initialisation Time IE in the POSITIONING INFORMATION RESPONSE message.

If the UE TEG Information Request IE is included in the POSITIONING INFORMATION REQUEST message and set to “onDemand”, the NG-RAN node shall, if supported, provide the UE Tx Timing Error Group (TEG) association in the POSITIONING INFORMATION RESPONSE message.

If the UE TEG Information Request IE is set to “periodic”, the NG-RAN node shall, if supported, reply with the POSITIONING INFORMATION RESPONSE message without including any UE Tx TEG association in this message. The NG-RAN node shall then periodically initiate the Positioning Information Update procedure for reporting the UE Tx TEG association, with the requested reporting periodicity.

In some embodiments, the POSITIONING INFORMATION RESPONSE message is defined as shown in Table 1 and is sent by the NG-RAN node to provide positioning information.

### Direction: NG-RAN Node→LMF.

TABLE 1

| | | | | | | |
|---|---|---|---|---|---|---|
| | | | IE type and | Semantics | | Assigned |
| IE/Group Name | Presence | Range | reference | description | Criticality | Criticality |

| | | | | |
|---|---|---|---|---|
| Message Type | M | 9.2.3 | YES | reject |
| NRPPa | M | 9.2.4 | — | |
| Transaction ID | | | | |
| SRS | O | 9.2.28 | YES | ignore |
| Configuration | | | | |
| SFN | O | Relative | YES | ignore |
| Initialisation | | Time 1900 | | |
| Time | | 9.2.36 | | |
| Criticality | O | 9.2.2 | YES | ignore |
| Diagnostics | | | | |
| UE Tx TEG | O | 9.2.78 | YES | ignore |
| Association List | | | | |

In some embodiments, SFN Initialisation Time provides the time in seconds relative to a reference time, e.g., 00:00:00 on 1 Jan. 1900.

### SRS Configuration

The SRS Configuration information element contains the SRS configuration configured by the NG-RAN node for the UE. The SRS Configuration IE in some embodiments is defined as shown in Table 2.

TABLE 2

| | | | IE Type and | |
|---|---|---|---|---|
| IE/Group Name | Presence | Range | Reference | Semantics Description |
| SRS Carrier List | | 1 | | |
| >SRS Carrier List | | 1 . . . | | |
| Item | | <maxnoSRS- | | |
| | | Carriers> | | |
| >>Point A | M | | INTEGER | NR ARFCN |
| | | | (0 . . . 3279165) | |
| >>Uplink Channel | | 1 | | SCS-SpecificCarrier TS |
| BW-PerSCS-List | | | | 38.331 |
| >>>SCS Specific | | 1 . . . | | |
| Carrier | | <maxnoSCSs> | | |
| >>>>Offset To | M | | INTEGER(0 . . . | First usable RB to Point A |
| Carrier | | | 2199, . . .) | in the number of PRBs |
| >>>>Subcarrier | M | | ENUMERATED(kHz 15, | |
| Spacing | | | kHz 30, kHz 60, | |
| | | | kHz 120, . . .) | |
| >>>>Carrier | M | | INTEGER(1 . . . | |
| Bandwidth | | | 275, . . .) | |
| >>Active UL BWP | M | | | Only the configuration in |
| | | | | the active UL BWP is |
| | | | | needed. |
| >>>Location And | M | | INTEGER(0 . . . | BWP TS 38.331 |
| Bandwidth | | | 37949, . . .) | |
| >>>Subcarrier | M | | ENUMERATED(kHz 15, | |
| Spacing | | | kHz 30, kHz 60, | |
| | | | kHz 120, . . .) | |
| >>>Cyclic Prefix | M | | ENUMERATED(Normal, | |
| | | | Extended) | |
| >>>Tx Direct | M | | INTEGER(0 . . . | |
| Current Location | | | 3301, . . .) | |
| >>>Shift7dot5 kHz | O | | ENUMERATED(true, . . .) | |
| >>>SRS Config | M | | | SRS-Config as defined in |
| | | | | TS 38.331 |
| >>>>SRS | | 0 . . | | |
| Resource List | | <maxnoSRS- | | |
| | | Resources> | | |
| >>>>>SRS | M | | 9.2.29 | SRS-Resource as defined |
| Resource | | | | in TS 38.331 |
| >>>>Positioning | | 0 . . . | | |
| SRS Resource | | <maxnoSRS- | | |
| List | | PosResources> | | |
| >>>>>Positioning | M | | 9.2.30 | SRS-PosResource-r16 as |
| SRS Resource | | | | defined in TS 38.331 |
| >>>>SRS | | 0 . . . | | |
| Resource Set | | <maxnoSRS- | | |
| List | | ResourceSets> | | |
| >>>>>SRS | M | | 9.2.31 | SRS-ResourceSet as |
| Resource Set | | | | defined in TS 38.331 |
| >>>>Positioning | | 0 . . . | | |
| SRS Resource | | <maxnoSRS- | | |
| Set List | | PosResourceSets> | | |
| >>>>>Positioning | M | | 9.2.32 | SRS-PosResourceSet- |
| SRS Resource | | | | r16 as defined in TS |
| Set | | | | 38.331 |
| >>NR PCI | O | | INTEGER (0 . . . 1007) | Physical Cell ID of the cell |
| | | | | that contains the SRS |
| | | | | carrier |

### UE Tx TEG Association List

This information element contains the list of UE Tx TEG associations. The UE Tx TEG Association List IE in some embodiments is defined as shown in Table 3.

TABLE 3

| | | | IE type and | Semantics | | Assigned |
|---|---|---|---|---|---|---|
| IE/Group Name | Presence | Range | reference | description | Criticality | Criticality |
| UE Tx TEG | | 1 . . . | | | — | |
| Association | | <maxnoUETEGs> | | | | |
| item | | | | | | |
| >UE Tx TEG | M | | INTEGER (0 . . . 7) | | — | |
| ID | | | | | | |
| >Positioning | | 1 | | | — | |
| SRS | | | | | | |
| Resource ID | | | | | | |
| List | | | | | | |
| >>Positioning | | 1 . . . | | | — | |
| SRS | | <maxnoSRS- | | | | |
| Resource ID | | PosResources> | | | | |
| Item | | | | | | |
| >>>Positioning | M | | INTEGER(0 . . . 63) | | — | |
| SRS | | | | | | |
| Resource | | | | | | |
| ID | | | | | | |
| >Time Stamp | M | | 9.2.42 | | — | |
| >Carrier | | 0 . . . 1 | | Indicates the | — | |
| Frequency | | | | frequency of | | |
| | | | | the | | |
| | | | | positioning | | |
| | | | | SRS | | |
| | | | | resources | | |
| >>Point A | M | | INTEGER | NR ARFCN | — | |
| | | | (0 . . . 3279165) | | | |
| >>Offset to | M | | INTEGER | | — | |
| Carrier | | | (0.2199, . . . ) | | | |
| >UE Tx Timing | O | | Timing Error | Timing error | YES | ignore |
| Error Margin | | | Margin | margin | | |
| | | | 9.2.84 | associated to | | |
| | | | | the UE Tx | | |
| | | | | TEG ID. | | |

As another step, when SRS resources are known in LMF, the LMF requests measurements from one or more gNBs and for several TRPs. In particular, the Measurement procedure allows the LMF to request one or more TRPs in the NG-RAN node to perform and report positioning measurements. This procedure applies only if the NG-RAN node is a gNB.

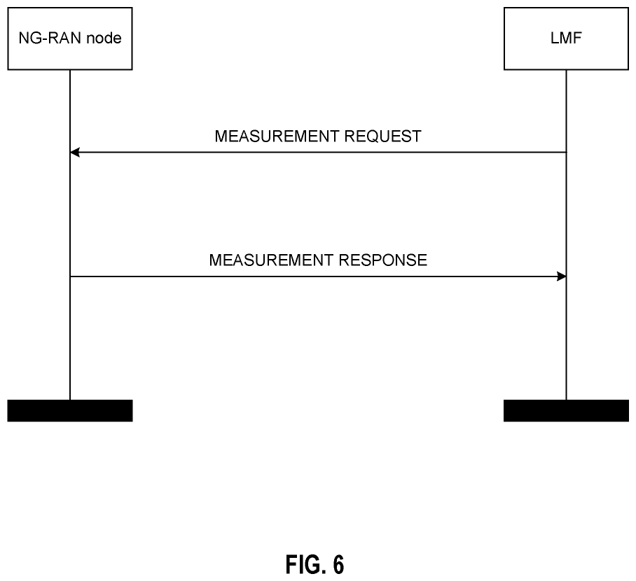

FIG. 6 shows successful operation of the Measurement procedure according to some embodiments.

The LMF initiates the procedure by sending a MEASUREMENT REQUEST message to the NG-RAN node, indicating in the TRP Measurement Request List IE the TRP(s) from which measurements are requested. The NG-RAN node shall use the included information to configure positioning measurements by the indicated TRP(s). If at least one of the requested measurements has been successful for at least one of the TRPs, the NG-RAN node shall reply with a MEASUREMENT RESPONSE message including the TRP Measurement Response List IE.

If the Report Characteristics IE is set to “OnDemand”, the NG-RAN node shall return the corresponding measurement results in the MEASUREMENT RESPONSE message, and the LMF shall consider that this reporting has been terminated by the NG-RAN node. If the Report Characteristics IE is set to “Periodic”, the NG-RAN node shall initiate the corresponding measurements, and it shall reply with the MEASUREMENT RESPONSE message without including any measurement results in the message. The NG-RAN node shall then periodically initiate the Measurement Report procedure for the corresponding measurements, with the requested reporting periodicity.

The POSITIONING INFORMATION REQUEST/RESPONSE procedure is sent on Next Generation (NG) Application Protocol (NGAP) UE associated signaling whereas MEASUREMENT REQUEST/RESPONSE is sent using UE non-associated signaling. Non UE-associated services in this regard may be related to the whole Next Generation (NG) interface instance between the NG-RAN node and AMF utilising a non UE-associated signalling connection. By contrast, UE-associated services may be related to one UE. NGAP functions that provide these services are associated with a UE-associated signalling connection that is maintained for the UE in question. See, e.g., 3GPP 38.413 V17.2.0 for the NGAP protocol.

So to summarize, SRSs are allocated by gNB per UE (a UE context exist) and the measurements are started per gNB (or TRP) and not per UE.

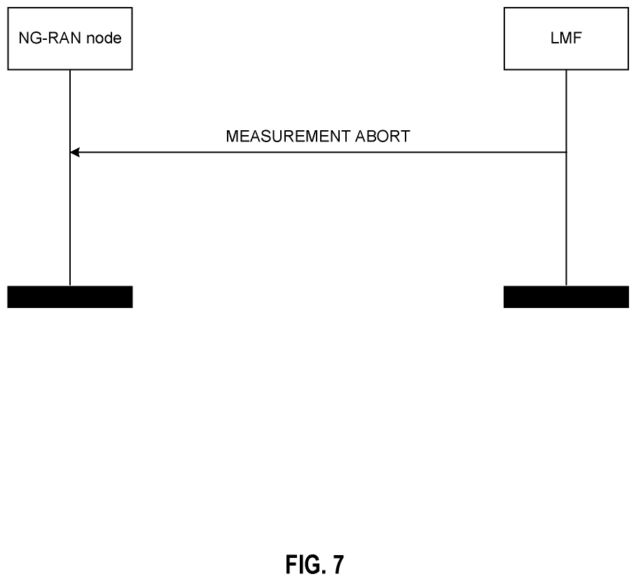

To stop the measurements, LMF can send the non-UE associated MEASUREMENT ABORT, as shown in FIG. 7.

To stop sending of SRS, LMF can send UE associated message POSITIONING DEACTIVATION. In particular, the Positioning Deactivation procedure is initiated by the LMF to indicate to the NG-RAN node that UL SRS transmission should be deactivated in the UE. This procedure applies only if the NG-RAN node is a gNB.

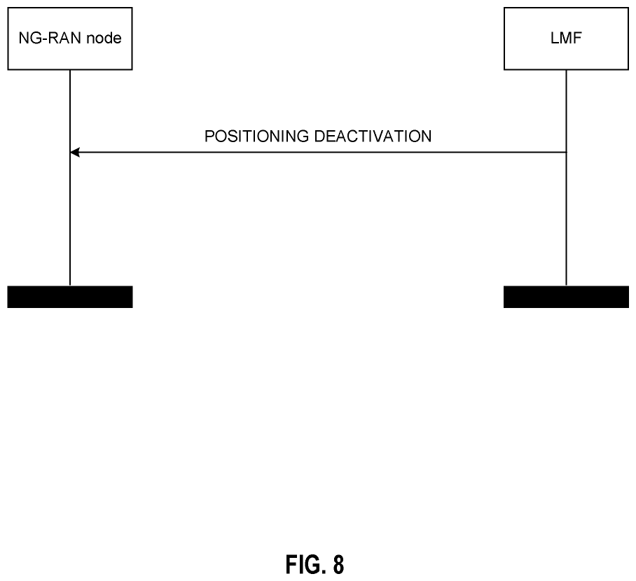

FIG. 8 shows one embodiment of successful operation of the Positioning Deactivation procedure. The LMF initiates the procedure by sending a POSITIONING DEACTIVATION message to the NG-RAN node. This message shall include an indication of the UL SRS resource set to be deactivated or release all the related resources.

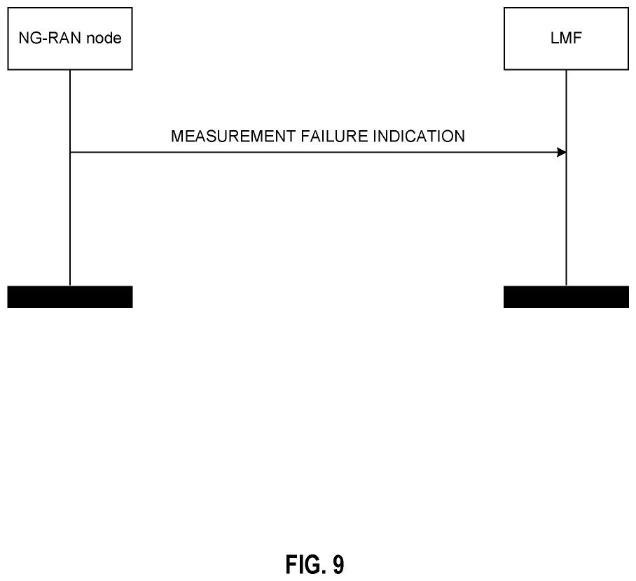

In case gNB cannot continue to measure, gNB can inform LMF, which then can take appropriate actions. gNB informs LMF by sending non-UE associated MEASUREMENT FAILURE INDICATION, as shown in FIG. 9.

For several positioning measurements, the gNB is requested to allocate SRS resources for the UE and to request the UE to start sending the SRS, in periodic, semi-persistent, or aperiodic way (one-shot). There are cases when the UE has to be released by gNB when positioning measurement is ongoing and the SRS is configured to be sent by the UE, e.g., due to deteriorating radio conditions, or UE has disappeared from the cell, or at mobility event, etc. In this case, LMF needs to be informed that positioning SRS transmission has stopped or failed. Some embodiments herein define a message from gNB to LMF to indicate that UE has been released or that the transmission of (periodic or semi-persistent) SRS has failed due to e.g., UE's disappearance, so that LMF can abort measurements in neighbor cells.

The only possible way existing in 3GPP is that MEASUREMENT FAILURE INDICATION is sent and all measurements are stopped by LMF. This means that if there is a failure in one TRP, all measurements have to be stopped for that UE and positioning fails. However, the MEASUREMENT FAILURE INDICATION message is non-UE associated, therefore the LMF cannot heretofore know for which UE the measurements have failed without searching for the Measurement id and correlate with UE context. This represents a complex and time consuming effort as there can be more than 65 thousand TRPs in an NG-RAN.

Some embodiments herein provide a number of methods to indicate to LMF, when positioning is ongoing and UE is sending UL SRS, that a UE is released or that the UE has stopped sending SRS, or other reasons why the UE transmission of SRS has stopped, such as UE has lost coverage or Uu connection is timed out etc. The LMF receives the new indication and can then stop measurements in TRPs where they have been started.

One embodiment herein provides an update to the existing MEASUREMENT FAILURE INDICATION with a cause (new for UE, no cause exists) indicating that the SRS is not sent with the list of TRPs that have stopped reporting the measurements.

Another embodiment herein defines a new Positioning Information Exchange class 2 procedure for UE failure indication from gNB to LMF.

Yet another embodiment herein provides a new class 2 failure indication procedure from gNB to LMF applicable to all positioning procedures, to reduce number of messages to be sent if several methods are used at the same time, like E-CID and multi-RTT.

A further embodiment herein updates the Positioning Information Update procedure with an indication that the SRS is not sent/stopped being sent.

With these embodiments, it will be possible by RAN node to inform LMF that UL signals for SRSs from a UE have stopped to be sent, and that LMF should terminate ongoing measurements in TRPs where measurements have started due to UE being e.g. released, or disappeared or in error scenario where UE lost coverage/timeOut etc, to save on network resources.

Certain embodiments may provide one or more of the following technical advantage(s). One advantage is a much simpler and robust handling in the network as no search process is needed to find a match between the SRS configuration for a UE context and a SRS configuration for a measurement context. This search would be needed when receiving the MEASUREMENT FAILURE INDICATION and the LMF would need to know the UE to which the failure is related.

Another advantage is that the LMF can distinguish between failure to send SRS from UE and a failure to measure by a TRP. When a failure to send SRS, the positioning procedure fails completely but if only measurement fails in certain TRPs, positioning procedure can continue, but with less measurements.

Consider now some embodiments from a gNB perspective, e.g., when implemented via NRPPa. In some embodiments, when gNB detects that SRS cannot be sent for a UE, the gNB sends a failure indication to LMF indicating that no SRS is sent or that the UE context is released. For example, at handover, positioning needs to be stopped in some cases, or UE sent to RRC Inactive or in error scenario or UE lost coverage/timeOut, etc.

In one embodiment, the failure indication can be an update to the existing MEASUREMENT FAILURE INDICATION with a cause (new UE cause, since no cause exists) indicating that the SRS is not sent. In one implementation of this embodiment, the gNB assumes that a measurement (not associated with a UE, only known by SRS resource configuration) has been configured in serving cell or TRP. The gNB searches for a match of SRS configuration in a UE context and an SRS configuration for a measurement. When a match is found, the non UE associated message MEASUREMENT FAILURE INDICATION is sent with a cause (new, no cause exists) indicating that the SRS is not sent. Alternatively or additionally, in another implementation of this embodiment, the gNB indicates the list of TRPs for which measurements have failed due to the cause that the SRS is not sent.

In another embodiment, the failure indication can be sent in a new Positioning Information Exchange class 2 failure indication procedure.

In yet another embodiment, the failure indication cab be sent in a new class 2 failure indication procedure applicable to all positioning procedures, to reduce number of messages to be sent if several methods are used at the same time, like Enhanced Cell ID (E-CID) and multi-Round Trip Time (multi-RTT).

To realize the failure indication, yet another embodiment herein updates the Positioning Information Update procedure with an indication that the SRS is not sent, i.e., the failure indication is the indication that the SRS is not sent.

In any of the above realization of the failure indication, the gNB may include a new cause value indicating the issue. For example, the cause may be one of (i) UE context released, handover; (ii) Ue context released, UE released; (iii) SRS failure; or (iv) UE lost coverage/connection timeOut. In one embodiment where the failure indication is an update to the existing MEASUREMENT FAILURE INDICATION, the gNB may indicate the list of TRPs for which measurements have failed due to these causes.

Consider now some embodiments from an LMF perspective, e.g., when implemented via NRPPa. In some embodiments, the LMF receives an indication that SRS is not sent. At reception, the LMF stops measurements in all or some TRPs.

In one embodiment, the indication is an update to the existing MEASUREMENT FAILURE INDICATION with a list of TRPs for which measurements have failed and a cause (new UE cause, no cause exists) indicating that the SRS is not sent. In this case, the LMF in some embodiments stops measurements in the list of TRPs signaled.

In another embodiment, the indication is received in a new Positioning Information Exchange class 2 failure indication procedure.

In yet another embodiment, the indication is received in a new class 2 failure indication procedure applicable to all positioning procedures, to reduce the number of messages to be sent if several methods are used at the same time, like E-CID and multi-RTT.

Still another embodiment updates the Positioning Information Update with indication that the SRS is not sent.

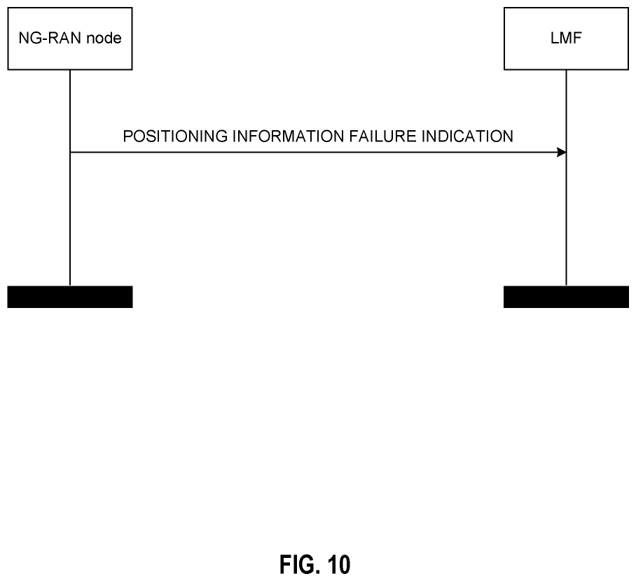

Without loss of generality, FIG. 10 shows an example of the new message described in step 2b above that can be introduced into the NRPPa specification, e.g., as otherwise specified by TS 38.455 V17.2.0. In particular, FIG. 10 shows successful operation of a Positioning Information Failure Indication procedure according to some embodiments. The purpose of the Positioning Information Failure Indication procedure is for the NG-RAN node to notify the LMF that the positioning information is no longer valid. In the Positioning Information Failure Indication procedure, the NG-RAN node sends a POSITIONING INFORMATION FAILURE INDICATION message to the LMF, where the POSITIONING INFORMATION FAILURE INDICATION message is an example of the new message described in step 2b above. The POSITIONING INFORMATION FAILURE INDICATION message is thereby one example of the second message 16-2 in FIG. 1.

Upon reception of the POSITIONING INFORMATION FAILURE INDICATION message, the LMF shall consider that the positioning information for the UE is no longer valid.

In some embodiments, the POSITIONING INFORMATION FAILURE INDICATION message is as defined in Table 4 and is sent by NG-RAN node to indicate that the positioning information is no longer valid.

### Direction: NG-RAN Node→LMF.

TABLE 4

| | | | | |
|---|---|---|---|---|
| | | | IE type and | Semantics |
| IE/Group Name | Presence | Range | reference | description |

| | | |
|---|---|---|
| Message Type | M | 9.2.3 |
| NRPPa | M | 9.2.4 |
| Transaction ID | | |
| LMF UE | M | INTEGER (1 . . . |
| Measurement ID | | 15, . . . , 16 . . . |
| | | 256) |
| RAN UE | M | INTEGER (1 . . . |
| Measurement ID | | 15, . . . , 16 . . . |
| | | 256) |
| Cause | M | 9.2.1 |

The purpose of the cause information element is to indicate the reason for a particular event for the whole protocol. The cause information element may be as defined in Table 5.

TABLE 5

| | | | | |
|---|---|---|---|---|
| | | | | Semantics |
| | | | IE Type and | Descrip- |
| IE/Group Name | Presence | Range | Reference | tion |

| | | |
|---|---|---|
| CHOICE Cause | M | |
| Group | | |
| >Radio Network | | |
| Layer | | |
| >>Radio Network | M | ENUMERATED |
| Layer Cause | | (Unspecified, |
| | | Requested Item |
| | | not Supported, |
| | | Requested Item |
| | | Temporarily not |
| | | Available, . . . , |
| | | Serving NG-RAN |
| | | node changed, |
| | | Requested Item |
| | | not Supported |
| | | on Time, UE |
| | | connection lost) |
| >Protocol | | |
| >>Protocol Cause | M | ENUMERATED |
| | | (Transfer Syntax |
| | | Error, |
| | | Abstract Syntax |
| | | Error (Reject), |
| | | Abstract Syntax |
| | | Error (Ignore and |
| | | Notify), |
| | | Message not |
| | | Compatible with |
| | | Receiver State, |
| | | Semantic Error, |
| | | Unspecified, |
| | | Abstract Syntax |
| | | Error (Falsely |
| | | Constructed |
| | | Message), . . .) |
| >Misc | | |
| >>Miscellaneous | M | ENUMERATED |
| Cause | | (Unspecified, . . .) |

The meaning of the different cause values is described in Table 6. In general, “not supported” cause values indicate that the concerned capability is missing. On the other hand, “not available” cause values indicate that the concerned capability is present, but insufficient resources were available to perform the requested action.

TABLE 6

| Radio Network | |
|---|---|
| Layer cause | Meaning |
| Unspecified | Sent when none of the above cause values applies |
| | but still the cause is Radio Network Layer related |
| Requested Item not | The NG-RAN node does not support the requested |
| Supported | measurement object, or cannot provide the |
| | requested information item. |
| Requested Item | The NG-RAN node can temporarily not provide the |
| Temporarily not | requested measurement object or information item. |
| Available | |
| Serving NG-RAN | The UE has moved to another serving NG-RAN |
| node changed | node. |
| Requested Item not | The NG-RAN node is unable to provide the |
| Supported on Time | measurement results on time. |
| UE connection lost | The connection with the UE is has been |
| | terminated/lost |

Some embodiments herein are related to the procedure where first the LMF triggers setup of resources (done vie Ue connection) and then starts measurements (just indicate SRS resources to measure, not indicating UE) in one or more TRPs/gNBs. Some embodiments herein enable a way in 3GPP to allow the gNB holding the Ue context to trigger the release (if a measurement has been configured in the cell that UE is located, then gNB could search for matching SRS and trigger, but this search is not necessarily so that the measurements have been configured in the serving cell).

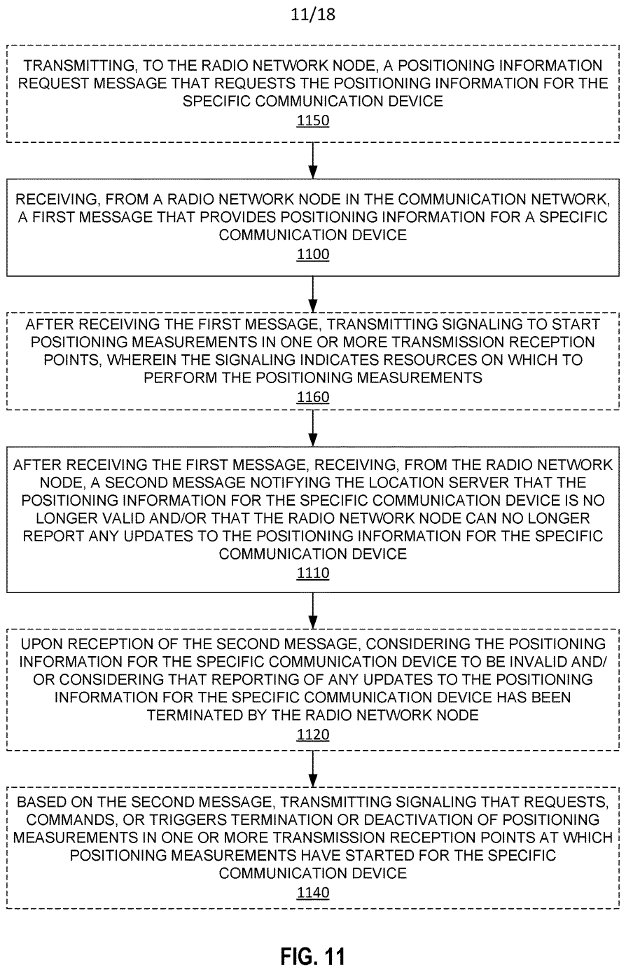

In view of the modifications and variations herein, FIG. 11 depicts a method performed by a location server 14 configured for use in a communication network 10 in accordance with particular embodiments.

In some embodiments, the method includes receiving, from a radio network node 18 in the communication network 10, a first message 16-1 that provides positioning information 20 for a specific communication device 12 (Block 1100). In some embodiments, for example, the method includes transmitting, to the radio network node 18, a positioning information request message 22 that requests the positioning information 20 for the specific communication device 12 (Block 1150), in which case the first message 16-1 may be received as a response to the positioning information request message 22.

Regardless, in some embodiments, the method includes, after receiving the first message 16-1, receiving, from the radio network node 18, a second message 16-2 notifying the location server 14 that the positioning information 20 for the specific communication device 12 is no longer valid and/or that the radio network node 18 can no longer report any updates to the positioning information 20 for the specific communication device 12 (Block 1110).

In some embodiments, the method includes, upon reception of the second message 16-2, considering the positioning information 20 for the specific communication device 12 to be invalid and/or considering that reporting of any updates to the positioning information 20 for the specific communication device 12 has been terminated by the radio network node 18 (Block 1120).

In some embodiments, the method includes, based on the second message 16-2, transmitting signaling that requests, commands, or triggers termination or deactivation of positioning measurements in one or more transmission reception points 20-1, 20-2 . . . 20-N at which positioning measurements have started for the specific communication device 12 (Block 1140).

In some embodiments, the method also includes, after receiving the first message 16-1, transmitting signaling to start positioning measurements in one or more transmission reception points 20-1, 20-2 . . . 20-N, wherein the signaling indicates resources 25 on which to perform the positioning measurements (Block 1160).

In some embodiments, the second message 16-2 indicates that the positioning information 20 for the specific communication device 12 is no longer valid.

In some embodiments, the second message 16-2 indicates the radio network node 18 can no longer report any updates to the positioning information 20 for the specific communication device 12.

In some embodiments, the first message 16-1 is a POSITIONING INFORMATION RESPONSE message.

In some embodiments, the second message 16-2 is received via device-associated signaling that is associated with the specific communication device 12.

In some embodiments, the second message 16-2 is received over a device-associated signaling connection that is associated with the specific communication device 12. In some embodiments, the method further comprises determining the specific communication device 12 for which the positioning information 20 is no longer valid, based on the specific communication device 12 being associated with device-associated signaling or a device-associated signaling connection via which the second message 16-2 is received. In some embodiments, determining the specific communication device 12 is performed without searching, across multiple transmission reception points 20-1, 20-2 . . . 20-N associated with the radio network node 18, for a match between a sounding reference signal, SRS, configuration for a device context and an SRS configuration for a measurement context. In other embodiments, determining the specific communication device 12 is performed without searching, across multiple transmission reception points 20-1, 20-2 . . . 20-N associated with the radio network node 18, for a match between a measurement identifier in a device context and a measurement identifier in a measurement context.

In some embodiments, the second message 16-2 is a POSITIONING INFORMATION FAILURE message or a POSITIONING INFORMATION FAILURE INDICATION message.

In some embodiments, the second message 16-2 is received as part of a Positioning Information Exchange class 2 failure indication procedure.

In some embodiments, the second message 16-2 is a POSITIONING INFORMATION UPDATE message that lacks any update to the positioning information 20 for the specific communication device 12.

In some embodiments, the second message 16-2 is received as part of a Positioning Information Update procedure.

In some embodiments, the second message 16-2 includes at least a positioning protocol transaction identifier. In other embodiments, the second message 16-2 includes at least a location server device measurement identifier. In yet other embodiments, the second message 16-2 includes at least a radio network node device measurement identifier.

In some embodiments, the second message 16-2 includes a cause 24 indicating a reason why the positioning information 20 for the specific communication device 12 is no longer valid and/or why the radio network node 18 can no longer report any updates to the positioning information 20 for the specific communication device 12. In some embodiments, the cause 24 is a radio network layer cause. In some embodiments, the cause 24 is a connection with the specific communication device 12 has been terminated, has been lost, or has timed out. In other embodiments, the cause 24 is the specific communication device 12 has lost coverage. In some embodiments, the cause 24 is a context of the specific communication device 12 has been released. In other embodiments, the cause 24 is a context of the specific communication device 12 has been released in association with a mobility of the specific communication device 12. In yet other embodiments, the cause 24 is a context of the specific communication device 12 has been released in association with a release of the specific communication device 12. In some embodiments, the cause 24 is failure by the specific communication device 12 to send sounding resource signaling, SRS. In other embodiments, the cause 24 is SRS is not or cannot be sent by the specific communication device 12. In yet other embodiments, the cause 24 is the specific communication device 12 has stopped sending SRS. In some embodiments, the cause 24 is the specific communication device 12 being released, disappearing, or experiencing an error.

In some embodiments, the second message 16-2 is received during ongoing positioning of the communication device 12.

In some embodiments, the method further comprises, based on the second message 16-2, determining that the radio network node 18 has terminated reporting of any updates to the positioning information 20 for the specific communication device 12.

In some embodiments, the method further comprises, based on the second message 16-2, transmitting signaling that requests, commands, or triggers one or more transmission reception points 20-1, 20-2 . . . 20-N associated with the radio network node 18 to stop or abort one or more positioning measurements for the specific communication device 12.

In some embodiments, the method further comprises, based on the second message 16-2, determining one or more transmission reception points 20-1, 20-2 . . . 20-N at which one or more positioning measurements have been started for the specific communication device 12 and transmitting signaling that requests, commands, or triggers the one or more transmission reception points 20-1, 20-2 . . . 20-N to abort or deactivate the one or more positioning measurements for the specific communication device 12.

In some embodiments, the method further comprises, based on the second message 16-2, determining one or more transmission reception points 20-1, 20-2 . . . 20-N at which resources 25 have been allocated for positioning of the specific communication device 12 and transmitting signaling that requests, commands, or triggers the one or more transmission reception points 20-1, 20-2 . . . 20-N to release or deactivate resources 25 that have been allocated for positioning of the specific communication device 12.

In some embodiments, the method further comprises transmitting, to the radio network node 18, a positioning information request message that requests the positioning information 20 for the specific communication device 12, and wherein the first message 16-1 is received as a response to the positioning information request message.

In some embodiments, the positioning information 20 is information for configuring positioning of the specific communication device 12. In other embodiments, the positioning information 20 is alternatively or additionally information for configuring positioning measurements for positioning of the specific communication device 12. In yet other embodiments, the positioning information 20 is alternatively or additionally information for configuring resources 25 on which are to be performed positioning measurements for positioning of the specific communication device 12.

In some embodiments, the positioning information 20 includes at least a sounding reference signal, SRS, configuration for the specific communication device 12. In other embodiments, the positioning information 20 includes at least a System Frame Number, SFN, initialization time. In other embodiments, the positioning information 20 includes at least a UE Tx timing error group, TEG, Association List.

In some embodiments, the location server 14 implements a location management function, LMF.

In some embodiments, the radio network node 18 is an NG-RAN node.

In some embodiments, the first and second messages 16-1, 16-2 are each received via a New Radio, NR, Positioning Protocol, NRPPa.

In some embodiments, the radio network node 18 is a gNodeB.

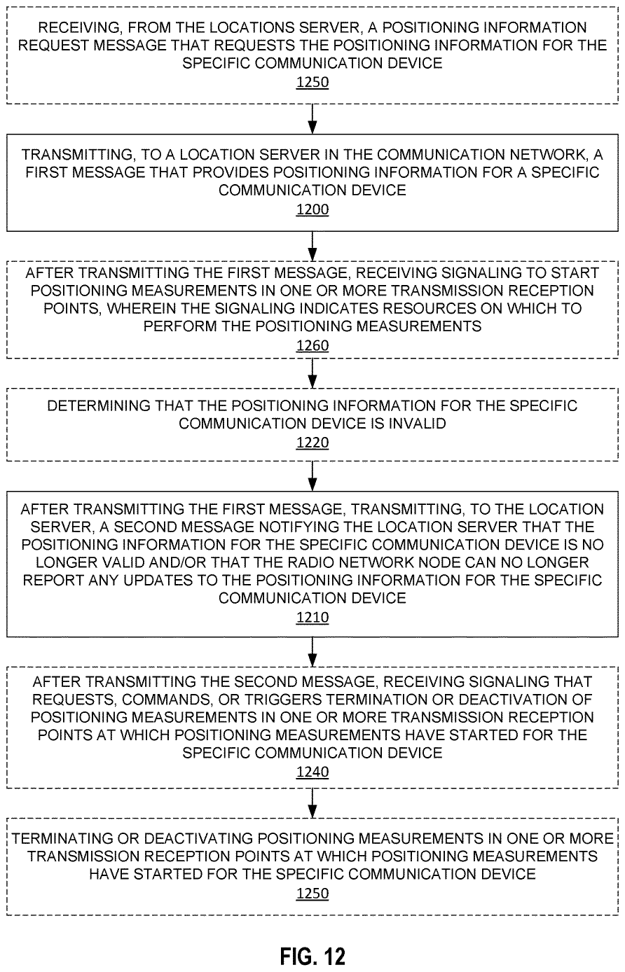

FIG. 12 depicts a method performed by a radio network node 18 configured for use in a communication network 10.

In some embodiments, the method includes transmitting, to a location server 14 in the communication network 10, a first message 16-1 that provides positioning information 20 for a specific communication device 12 (Block 1200). In one embodiment, for example, the method includes receiving, from the location server 14, a positioning information request message that requests the positioning information 20 for the specific communication device 12 (Block 1205), in which case the first message 16-1 may be a response to the positioning information request message.

Regardless, in some embodiments, the method includes, after transmitting the first message 16-1, transmitting, to the location server 14, a second message 16-2 notifying the location server 14 that the positioning information 20 for the specific communication device 12 is no longer valid and/or that the radio network node 18 can no longer report any updates to the positioning information 20 for the specific communication device 12 (Block 1210).

In some embodiments, the method further includes terminating or deactivating positioning measurements in one or more transmission reception points 20-1, 20-2 . . . 20-N at which positioning measurements have started for the specific communication device 12 (Block 1250).

In some embodiments, the method also includes determining that the positioning information 20 for the specific communication device 12 is invalid (Block 1220).

In some embodiments, the method includes, after transmitting the first message 16-1, receiving signaling to start positioning measurements in one or more transmission reception points 20-1, 20-2 . . . 20-N, wherein the signaling indicates resources 25 on which to perform the positioning measurements (Block 1260).

In some embodiments, the second message 16-2 indicates that the positioning information 20 for the specific communication device 12 is no longer valid.

In some embodiments, the second message 16-2 indicates the radio network node 18 can no longer report any updates to the positioning information 20 for the specific communication device 12.

In some embodiments, the first message 16-1 is a POSITIONING INFORMATION RESPONSE message.

In some embodiments, the second message 16-2 is transmitted via device-associated signaling that is associated with the specific communication device 12.

In some embodiments, the second message 16-2 is transmitted over a device-associated signaling connection that is associated with the specific communication device 12.

In some embodiments, the second message 16-2 is a POSITIONING INFORMATION FAILURE message or a POSITIONING INFORMATION FAILURE INDICATION message.

In some embodiments, the second message 16-2 is transmitted as part of a Positioning Information Exchange class 2 failure indication procedure.

In some embodiments, the second message 16-2 is a POSITIONING INFORMATION UPDATE message that lacks any update to the positioning information 20 for the specific communication device 12.

In some embodiments, the second message 16-2 is transmitted as part of a Positioning Information Update procedure.

In some embodiments, the second message 16-2 includes at least a positioning protocol transaction identifier. In other embodiments, the second message 16-2 includes at least a location server device measurement identifier. In yet other embodiments, the second message 16-2 includes at least a radio network node device measurement identifier.

In some embodiments, the second message 16-2 includes a cause 24 indicating a reason why the positioning information 20 for the specific communication device 12 is no longer valid and/or why the radio network node 18 can no longer report any updates to the positioning information 20 for the specific communication device 12. In some embodiments, the cause 24 is a radio network layer cause. In some embodiments, the cause 24 is a connection with the specific communication device 12 has been terminated, has been lost, or has timed out. In other embodiments, the cause 24 is the specific communication device 12 has lost coverage. In some embodiments, the cause 24 is a context of the specific communication device 12 has been released. In other embodiments, the cause 24 is a context of the specific communication device 12 has been released in association with a mobility of the specific communication device 12. In yet other embodiments, the cause 24 is a context of the specific communication device 12 has been released in association with a release of the specific communication device 12. In some embodiments, the cause 24 is failure by the specific communication device 12 to send sounding resource signaling, SRS. In other embodiments, the cause 24 is SRS is not or cannot be sent by the specific communication device 12. In yet other embodiments, the cause 24 is the specific communication device 12 has stopped sending SRS. In some embodiments, the cause 24 is the specific communication device 12 being released, disappearing, or experiencing an error.

In some embodiments, the second message 16-2 is received during ongoing positioning of the communication device 12.

In some embodiments, the method further comprises terminating reporting of any updates to the positioning information 20 for the specific communication device 12.

In some embodiments, the method further comprises, after transmitting the second message 16-2, receiving signaling that requests, commands, or triggers one or more transmission reception points 20-1, 20-2 . . . 20-N associated with the radio network node 18 to stop or abort one or more positioning measurements for the specific communication device 12. In other embodiments, the method further comprises receiving signaling that requests, commands, or triggers termination or deactivation of positioning measurements in one or more transmission reception points 20-1, 20-2 . . . 20-N at which positioning measurements have started for the specific communication device 12 (Block 1240).

In some embodiments, the method further comprises receiving signaling that requests, commands, or triggers the one or more transmission reception points 20-1, 20-2 . . . 20-N to abort or deactivate the one or more positioning measurements for the specific communication device 12.

In some embodiments, the method further comprises receiving signaling that requests, commands, or triggers the one or more transmission reception points 20-1, 20-2 . . . 20-N to release or deactivate resources 25 that have been allocated for positioning of the specific communication device 12.

In some embodiments, the method further comprises receiving, from the location server 14, a positioning information request message that requests the positioning information 20 for the specific communication device 12, and wherein the first message 16-1 is transmitted as a response to the positioning information request message.

In some embodiments, the positioning information 20 is information for configuring positioning of the specific communication device 12. In other embodiments, the positioning information 20 is information alternatively or additionally for configuring positioning measurements for positioning of the specific communication device 12. In yet other embodiments, the positioning information 20 is information alternatively or additionally for configuring resources 25 on which are to be performed positioning measurements for positioning of the specific communication device 12.

In some embodiments, the positioning information 20 includes at least a sounding reference signal, SRS, configuration for the specific communication device 12. In other embodiments, the positioning information 20 includes at least a System Frame Number, SFN, initialization time. In yet other embodiments, the positioning information 20 includes at least a UE Tx timing error group, TEG, Association List.

In some embodiments, the location server 14 implements a location management function, LMF.

In some embodiments, the radio network node 18 is an NG-RAN node.

In some embodiments, the first and second messages 16-1, 16-2 are each received via a New Radio, NR, Positioning Protocol, NRPPa.

In some embodiments, the radio network node 18 is a gNodeB.

Alternatively or additionally, other embodiments herein introduce messaging for a radio network node 18 to notify a location server 14 that the radio network node 18 can no longer report positioning measurements, e.g., with the indicated reason being that the specific communication device 12 has lost its connection. In some embodiments, this messaging includes a list of one or more transmission reception points 20-1, 20-2 . . . 20-N for which the positioning measurements have failed. By providing such a list, even if the messaging is received via non-device-associate signaling, the location server 14 is able to efficiently determine for which communication device 12 positioning measurements have failed and then trigger termination of positioning for that device. For example, rather than having to perform correlation or other processing over all possible transmission reception points 20-1, 20-2 . . . 20-N to deduce for which specific communication device 12 positioning measurements have failed, as would otherwise be required without the list, the list in the messaging reduces the location server's 14 search space to only those transmission reception points 20-1, 20-2 . . . 20-N in the list.

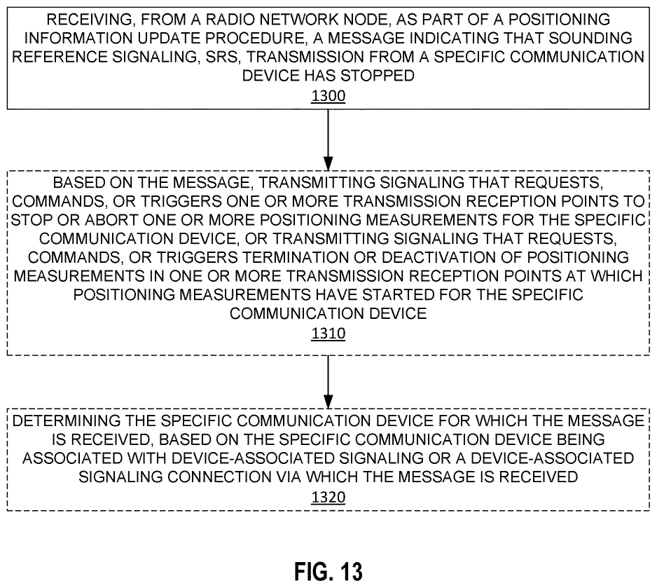

FIG. 13 depicts a method performed by a location server 14 configured for use in a communication network 10 in accordance with some embodiments. The method includes receiving, from a radio network node 18, as part of a Positioning Information Update procedure, a message 16-2U indicating that sounding reference signaling, SRS, transmission from a specific communication device 12 has stopped (Block 1300).

In some embodiments, the method also includes, based on the message 16-2U, determining that an SRS configuration previously received from the radio network node 18 for the specific communication device 12 is invalid and/or that reporting of any updates to an SRS configuration for the specific communication device 12 has been terminated by the radio network node 18.

In some embodiments, the method further comprises, based on the message 16-2U, transmitting signaling that requests, commands, or triggers one or more transmission reception points 20-1, 20-2 . . . 20-N to stop or abort one or more positioning measurements for the specific communication device 12, or transmitting signaling that requests, commands, or triggers termination or deactivation of positioning measurements in one or more transmission reception points 20-1, 20-2 . . . 20-N at which positioning measurements have started for the specific communication device 12 (Block 1310).

In some embodiments, the method further comprises, based on the message 16-2U, determining one or more transmission reception points 20-1, 20-2 . . . 20-N at which one or more positioning measurements have been started for the specific communication device 12 and transmitting signaling that requests, commands, or triggers the one or more transmission reception points 20-1, 20-2 . . . 20-N to abort or deactivate the one or more positioning measurements for the specific communication device 12. In other embodiments, the method further comprises, based on the message 16-2U, alternatively or additionally determining one or more transmission reception points 20-1, 20-2 . . . 20-N at which resources 25 have been allocated for positioning of the specific communication device 12 and transmitting signaling that requests, commands, or triggers the one or more transmission reception points 20-1, 20-2 . . . 20-N to release or deactivate resources 25 that have been allocated for positioning of the specific communication device 12.

In some embodiments, the message 16-2U is a POSITIONING INFORMATION UPDATE message.

In some embodiments, the Positioning Information Update procedure is a procedure initiated by the radio network node 18 to indicate to the location server 14 that a change has occurred in an SRS configuration for the specific communication device 12, and the message 16-2U lacks any update to the SRS configuration for the specific communication device 12.

In some embodiments, the message 16-2U is received via device-associated signaling that is associated with the specific communication device 12. In other embodiments, the message 16-2U is received over a device-associated signaling connection that is associated with the specific communication device 12.

In some embodiments, the method further comprises determining the specific communication device 12 for which the message 16-2U is received, based on the specific communication device 12 being associated with device-associated signaling or a device-associated signaling connection via which the message 16-2U is received (Block 1320). In some embodiments, determining the specific communication device 12 is performed without searching, across multiple transmission reception points 20-1, 20-2 . . . 20-N associated with the radio network node 18, for a match between an SRS configuration for a device context and an SRS configuration for a measurement context. In other embodiments, determining the specific communication device 12 is performed without searching, across multiple transmission reception points 20-1, 20-2 . . . 20-N associated with the radio network node 18, for a match between a measurement identifier in a device context and a measurement identifier in a measurement context.

In some embodiments, the location server 14 implements a location management function, LMF. In some embodiments, the radio network node 18 is a gNodeB, and wherein the message 16-2U is received via a New Radio, NR, Positioning Protocol, NRPPa.

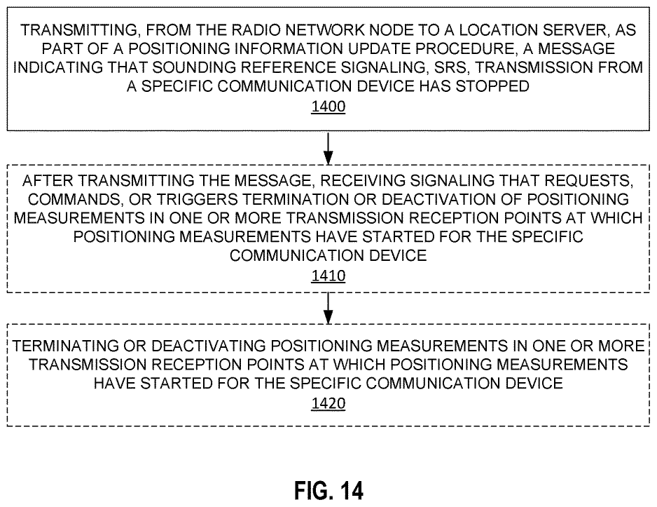

FIG. 14 depicts a method performed by a radio network node 18 configured for use in a communication network 10 in accordance with some embodiments. The method includes transmitting, from the radio network node 18 to a location server 14, as part of a Positioning Information Update procedure, a message 16-2U indicating that sounding reference signaling, SRS, transmission from a specific communication device 12 has stopped (Block 1400).

In some embodiments, the method further comprises receiving signaling that requests, commands, or triggers termination or deactivation of positioning measurements in one or more transmission reception points 20-1, 20-2 . . . 20-N at which positioning measurements have started for the specific communication device 12 (Block 1410).

In some embodiments, the method further comprises terminating or deactivating positioning measurements in one or more transmission reception points 20-1, 20-2 . . . 20-N at which positioning measurements have started for the specific communication device 12 (Block 1430).

In some embodiments, the message 16-2U is a POSITIONING INFORMATION UPDATE message.

In some embodiments, the Positioning Information Update procedure is a procedure initiated by the radio network node 18 to indicate to the location server 14 that a change has occurred in an SRS configuration for the specific communication device 12, and the message 16-2U lacks any update to the SRS configuration for the specific communication device 12.

In some embodiments, the message 16-2U is transmitted via device-associated signaling that is associated with the specific communication device 12. In other embodiments, the message 16-2U is transmitted over a device-associated signaling connection that is associated with the specific communication device 12.

In some embodiments, the location server 14 implements a location management function, LMF. In some embodiments, the radio network node 18 is a gNodeB, and wherein the message 16-2U is transmitted via a New Radio, NR, Positioning Protocol, NRPPa.

Embodiments herein also include corresponding apparatuses. Embodiments herein for instance include a location server 14 configured to perform any of the steps of any of the embodiments described above for the location server 14.

Embodiments also include a location server 14 comprising processing circuitry and power supply circuitry. The processing circuitry is configured to perform any of the steps of any of the embodiments described above for the location server 14. The power supply circuitry is configured to supply power to the location server 14.

Embodiments further include a location server 14 comprising processing circuitry. The processing circuitry is configured to perform any of the steps of any of the embodiments described above for the location server 14. In some embodiments, the location server 14 further comprises communication circuitry.

Embodiments further include a location server 14 comprising processing circuitry and memory. The memory contains instructions executable by the processing circuitry whereby the location server 14 is configured to perform any of the steps of any of the embodiments described above for the location server 14.

Embodiments herein also include a radio network node 18 configured to perform any of the steps of any of the embodiments described above for the radio network node 18.

Embodiments also include a radio network node 18 comprising processing circuitry and power supply circuitry. The processing circuitry is configured to perform any of the steps of any of the embodiments described above for the radio network node 18. The power supply circuitry is configured to supply power to the radio network node 18.

Embodiments further include a radio network node 18 comprising processing circuitry. The processing circuitry is configured to perform any of the steps of any of the embodiments described above for the radio network node 18. In some embodiments, the radio network node 18 further comprises communication circuitry.

Embodiments further include a radio network node 18 comprising processing circuitry and memory. The memory contains instructions executable by the processing circuitry whereby the radio network node 18 is configured to perform any of the steps of any of the embodiments described above for the radio network node 18.

More particularly, the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

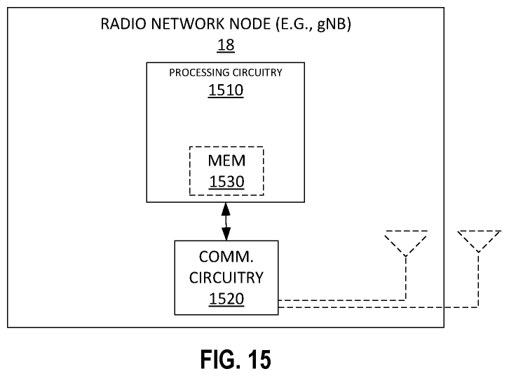

FIG. 15 for example illustrates a location server 14 as implemented in accordance with one or more embodiments. As shown, the location server 14 includes processing circuitry 1510 and communication circuitry 1520. The communication circuitry 1520 is configured to transmit and/or receive information to and/or from one or more other nodes, e.g., via any communication technology. The processing circuitry 1510 is configured to perform processing described above, e.g., in FIG. 11 and/or FIG. 13, such as by executing instructions stored in memory 1530. The processing circuitry 1510 in this regard may implement certain functional means, units, or modules.

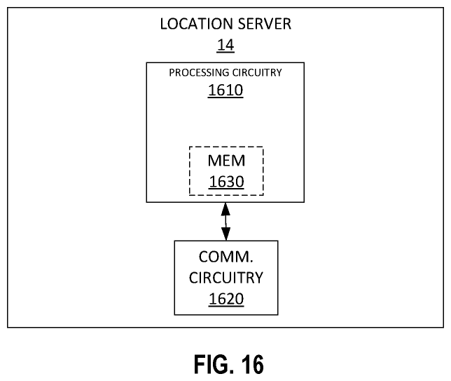

FIG. 16 illustrates a radio network node 18 as implemented in accordance with one or more embodiments. As shown, the radio network node 18 includes processing circuitry 1610 and communication circuitry 1620. The communication circuitry 1620 is configured to transmit and/or receive information to and/or from one or more other nodes, e.g., via any communication technology. The processing circuitry 1610 is configured to perform processing described above, e.g., in FIG. 12 and/or FIG. 14, such as by executing instructions stored in memory 1630. The processing circuitry 1610 in this regard may implement certain functional means, units, or modules.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

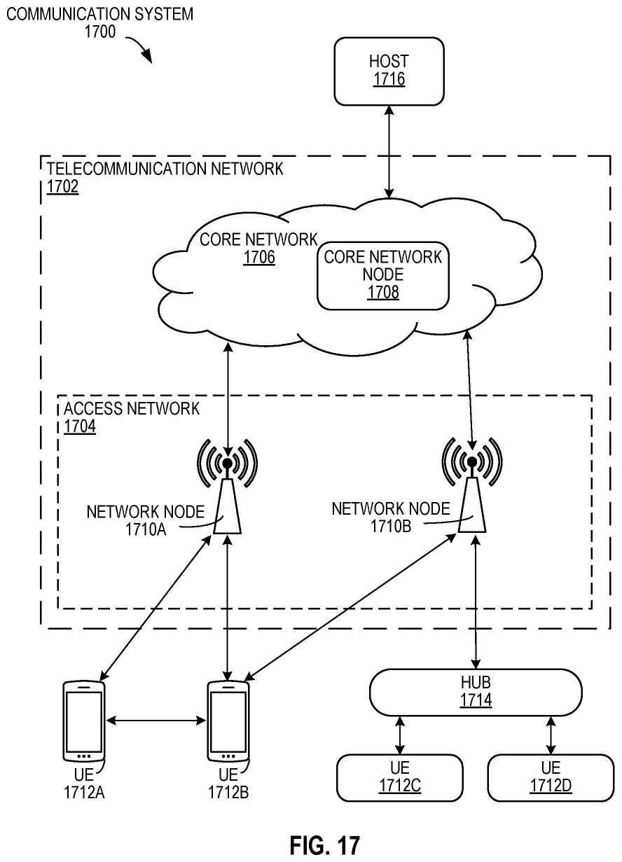

FIG. 17 shows an example of a communication system 1700 in accordance with some embodiments.

In the example, the communication system 1700 includes a telecommunication network 1702 that includes an access network 1704, such as a radio access network (RAN), and a core network 1706, which includes one or more core network nodes 1708. The access network 1704 includes one or more access network nodes, such as network nodes 1710a and 1710b (one or more of which may be generally referred to as network nodes 1710), or any other similar 3^{rd} Generation Partnership Project (3GPP) access node or non-3GPP access point. The network nodes 1710 facilitate direct or indirect connection of user equipment (UE), such as by connecting UEs 1712a, 1712b, 1712c, and 1712d (one or more of which may be generally referred to as UEs 1712) to the core network 1706 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1700 may include any number of wired or wireless networks, network nodes, UEs, and/or any other components or systems that may facilitate or participate in the communication of data and/or signals whether via wired or wireless connections. The communication system 1700 may include and/or interface with any type of communication, telecommunication, data, cellular, radio network, and/or other similar type of system.

The UEs 1712 may be any of a wide variety of communication devices, including wireless devices arranged, configured, and/or operable to communicate wirelessly with the network nodes 1710 and other communication devices. Similarly, the network nodes 1710 are arranged, capable, configured, and/or operable to communicate directly or indirectly with the UEs 1712 and/or with other network nodes or equipment in the telecommunication network 1702 to enable and/or provide network access, such as wireless network access, and/or to perform other functions, such as administration in the telecommunication network 1702.

In the depicted example, the core network 1706 connects the network nodes 1710 to one or more hosts, such as host 1716. These connections may be direct or indirect via one or more intermediary networks or devices. In other examples, network nodes may be directly coupled to hosts. The core network 1706 includes one more core network nodes (e.g., core network node 1708) that are structured with hardware and software components. Features of these components may be substantially similar to those described with respect to the UEs, network nodes, and/or hosts, such that the descriptions thereof are generally applicable to the corresponding components of the core network node 1708. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1716 may be under the ownership or control of a service provider other than an operator or provider of the access network 1704 and/or the telecommunication network 1702, and may be operated by the service provider or on behalf of the service provider. The host 1716 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1700 of FIG. 17 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1702 is a cellular network that implements 3GPP standardized features. Accordingly, the telecommunications network 1702 may support network slicing to provide different logical networks to different devices that are connected to the telecommunication network 1702. For example, the telecommunications network 1702 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1712 are configured to transmit and/or receive information without direct human interaction. For instance, a UE may be designed to transmit information to the access network 1704 on a predetermined schedule, when triggered by an internal or external event, or in response to requests from the access network 1704. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1714 communicates with the access network 1704 to facilitate indirect communication between one or more UEs (e.g., UE 1712c and/or 1712d) and network nodes (e.g., network node 1710b). In some examples, the hub 1714 may be a controller, router, content source and analytics, or any of the other communication devices described herein regarding UEs. For example, the hub 1714 may be a broadband router enabling access to the core network 1706 for the UEs. As another example, the hub 1714 may be a controller that sends commands or instructions to one or more actuators in the UEs. Commands or instructions may be received from the UEs, network nodes 1710, or by executable code, script, process, or other instructions in the hub 1714. As another example, the hub 1714 may be a data collector that acts as temporary storage for UE data and, in some embodiments, may perform analysis or other processing of the data. As another example, the hub 1714 may be a content source. For example, for a UE that is a VR headset, display, loudspeaker or other media delivery device, the hub 1714 may retrieve VR assets, video, audio, or other media or data related to sensory information via a network node, which the hub 1714 then provides to the UE either directly, after performing local processing, and/or after adding additional local content. In still another example, the hub 1714 acts as a proxy server or orchestrator for the UEs, in particular in if one or more of the UEs are low energy IoT devices.

The hub 1714 may have a constant/persistent or intermittent connection to the network node 1710b. The hub 1714 may also allow for a different communication scheme and/or schedule between the hub 1714 and UEs (e.g., UE 1712c and/or 1712d), and between the hub 1714 and the core network 1706. In other examples, the hub 1714 is connected to the core network 1706 and/or one or more UEs via a wired connection. Moreover, the hub 1714 may be configured to connect to an M2M service provider over the access network 1704 and/or to another UE over a direct connection. In some scenarios, UEs may establish a wireless connection with the network nodes 1710 while still connected via the hub 1714 via a wired or wireless connection. In some embodiments, the hub 1714 may be a dedicated hub—that is, a hub whose primary function is to route communications to/from the UEs from/to the network node 1710b. In other embodiments, the hub 1714 may be a non-dedicated hub—that is, a device which is capable of operating to route communications between the UEs and network node 1710b, but which is additionally capable of operating as a communication start and/or end point for certain data channels.

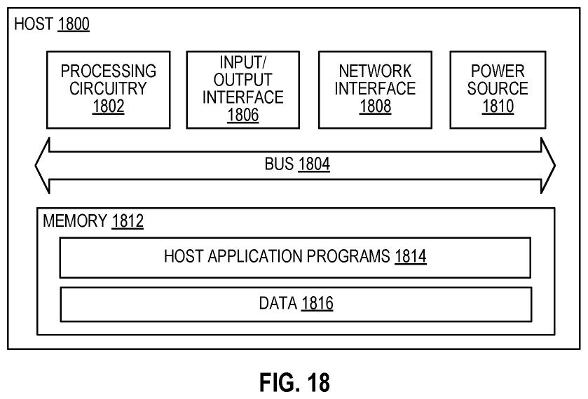

FIG. 18 is a block diagram of a host 1800, which may be an embodiment of the host 1716 of FIG. 17, in accordance with various aspects described herein. As used herein, the host 1800 may be or comprise various combinations hardware and/or software, including a standalone server, a blade server, a cloud-implemented server, a distributed server, a virtual machine, container, or processing resources in a server farm. The host 1800 may provide one or more services to one or more UEs.

The host 1800 includes processing circuitry 1802 that is operatively coupled via a bus 1804 to an input/output interface 1806, a network interface 1808, a power source 1810, and a memory 1812. Other components may be included in other embodiments. Features of these components may be substantially similar to those described with respect to the devices of previous figures, such as FIGS. 18 and QQ3, such that the descriptions thereof are generally applicable to the corresponding components of host 1800.

The memory 1812 may include one or more computer programs including one or more host application programs 1814 and data 1816, which may include user data, e.g., data generated by a UE for the host 1800 or data generated by the host 1800 for a UE. Embodiments of the host 1800 may utilize only a subset or all of the components shown. The host application programs 1814 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1814 may also provide for user authentication and licensing checks and may periodically report health, routes, and content availability to a central node, such as a device in or on the edge of a core network. Accordingly, the host 1800 may select and/or indicate a different host for over-the-top services for a UE. The host application programs 1814 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally. Some embodiments herein may be enumerated as follows.

### GROUP A EMBODIMENTS

A1. A method performed by a location server configured for use in a communication network, the method comprising:
receiving, from a radio network node in the communication network, a first message that provides positioning information for a specific communication device; and
after receiving the first message, receiving, from the radio network node, a second message notifying the location server that the positioning information for the specific communication device is no longer valid and/or that the radio network node can no longer report any updates to the positioning information for the specific communication device.

A2. The method of embodiment A1, wherein the second message indicates that the positioning information for the specific communication device is no longer valid.

A3. The method of any of embodiments A1-A2, wherein the second message indicates the radio network node can no longer report any updates to the positioning information for the specific communication device.

A4. The method of any of embodiments A1-A3, wherein the first message is a POSITIONING INFORMATION RESPONSE message.

A5. The method of any of embodiments A1-A4, wherein the second message is received via device-associated signaling that is associated with the specific communication device.

A6. The method of any of embodiments A1-A5, wherein the second message is received over a device-associated signaling connection that is associated with the specific communication device.

A7. The method of any of embodiments A5-A6, further comprising determining the specific communication device for which the positioning information is no longer valid, based on the specific communication device being associated with device-associated signaling or a device-associated signaling connection via which the second message is received.

A8. The method of embodiment A7, wherein determining the specific communication device is performed:
without searching, across multiple transmission reception points associated with the radio network node, for a match between a sounding reference signal, SRS, configuration for a device context and an SRS configuration for a measurement context; or
without searching, across multiple transmission reception points associated with the radio network node, for a match between a measurement identifier in a device context and a measurement identifier in a measurement context.

A9. The method of any of embodiments A1-A8, wherein the second message is a POSITIONING INFORMATION FAILURE message or a POSITIONING INFORMATION FAILURE INDICATION message.

A10. The method of any of embodiments A1-A8, wherein the second message is received as part of a Positioning Information Exchange class 2 failure indication procedure.

A11. The method of any of embodiments A1-A8, wherein the second message is a POSITIONING INFORMATION UPDATE message that lacks any update to the positioning information for the specific communication device.

A12 The method of any of embodiments A1-A8, wherein the second message is received as part of a Positioning Information Update procedure.

A13. The method of any of embodiments A1-A12, wherein the second message includes one or more of:
a positioning protocol transaction identifier;
a location server device measurement identifier; or
a radio network node device measurement identifier.

A14. The method of any of embodiments A1-A13, wherein the second message includes a cause indicating a reason why the positioning information for the specific communication device is no longer valid and/or why the radio network node can no longer report any updates to the positioning information for the specific communication device.

A15. The method of embodiment A14, wherein the cause is a radio network layer cause.

A16. The method of embodiment A14, wherein the cause is:
a connection with the specific communication device has been terminated, has been lost, or has timed out; or
the specific communication device has lost coverage.

A17. The method of embodiment A14, wherein the cause is:
a context of the specific communication device has been released;
a context of the specific communication device has been released in association with a mobility of the specific communication device; or
a context of the specific communication device has been released in association with a release of the specific communication device.

A18. The method of embodiment A14, wherein the cause is:
failure by the specific communication device to send sounding resource signaling, SRS; SRS is not or cannot be sent by the specific communication device; or
the specific communication device has stopped sending SRS.

A19. The method of embodiment A14, wherein the cause is the specific communication device being released, disappearing, or experiencing an error.

A20. The method of any of embodiments A1-A19, wherein the second message is received during ongoing positioning of the communication device.

A21. The method of any of embodiments A1-A20, wherein the method further comprises, based on the second message, determining that the radio network node has terminated reporting of any updates to the positioning information for the specific communication device.

A22. The method of any of embodiments A1-A21, wherein the method further comprises, upon reception of the second message, considering the positioning information for the specific communication device to be invalid and/or considering that reporting of any updates to the positioning information for the specific communication device has been terminated by the radio network node.

A23. The method of any of embodiments A1-A22, further comprising, based on the second message:
transmitting signaling that requests, commands, or triggers one or more transmission reception points to stop or abort one or more positioning measurements for the specific communication device; or
transmitting signaling that requests, commands, or triggers termination or deactivation of positioning measurements in one or more transmission reception points at which positioning measurements have started for the specific communication device.

A24. The method of any of embodiments A1-A23, wherein the method further comprises, based on the second message, determining one or more transmission reception points at which one or more positioning measurements have been started for the specific communication device and transmitting signaling that requests, commands, or triggers the one or more transmission reception points to abort or deactivate the one or more positioning measurements for the specific communication device.

A25. The method of any of embodiments A1-A23, wherein the method further comprises, based on the second message, determining one or more transmission reception points at which resources have been allocated for positioning of the specific communication device and transmitting signaling that requests, commands, or triggers the one or more transmission reception points to release or deactivate resources that have been allocated for positioning of the specific communication device.

A26. The method of any of embodiments A1-A25, further comprising transmitting, to the radio network node, a positioning information request message that requests the positioning information for the specific communication device, and wherein the first message is received as a response to the positioning information request message.

A27. The method of any of embodiments A1-A26, wherein the positioning information is information for:
configuring positioning of the specific communication device;
configuring positioning measurements for positioning of the specific communication device; and/or
configuring resources on which are to be performed positioning measurements for positioning of the specific communication device.

A28. The method of any of embodiments A1-A27, wherein the positioning information includes one or more of:
a sounding reference signal, SRS, configuration for the specific communication device;
a System Frame Number, SFN, initialization time; or
a UE Tx timing error group, TEG, Association List.

A29. The method of any of embodiments A1-A28, wherein the location server implements a location management function, LMF.

A30. The method of any of embodiments A1-A29, wherein the radio network node is an NG-RAN node.

A31. The method of any of embodiments A1-A30, wherein the first and second messages are each received via a New Radio, NR, Positioning Protocol, NRPPa.

A32. The method of any of embodiments A1-A31, wherein the radio network node is a gNodeB.

A33. The method of any of embodiments A1-A32, further comprising, after receiving the first message, transmitting signaling to start positioning measurements in one or more transmission reception points, wherein the signaling indicates resources on which to perform the positioning measurements, and wherein the second message is received after transmitting the signaling.

AA1. A method performed by a location server configured for use in a communication network, the method comprising:
receiving, from a radio network node in the communication network, a first message that indicates the radio network node is able to initiate positioning measurements; and
after receiving the first message, receiving, from the radio network node, a second message notifying the location server that the radio network node can no longer report the positioning measurements.

AA2. The method of embodiment AA1, wherein the second message includes a list of one or more transmission reception points for which the positioning measurements have failed.

AA3. The method of embodiment AA2, further comprising:
searching, selectively across the one or more transmission reception points included in the list, for a match between a sounding reference signal, SRS, configuration for a device context and an SRS configuration for a measurement context; or
searching, selectively across the one or more transmission reception points included in the list, for a match between a measurement identifier in a device context and a measurement identifier in a measurement context.

AA4. The method of any of embodiments AA2-AA3, further comprising determining, using the list of one or more transmission reception points, a specific communication device associated with the positioning measurements that have failed.

AA5. The method of embodiment AA4, further comprising:
stopping or aborting the positioning measurements in the one or more transmission reception points in the list; or
terminating the positioning measurements in the one or more transmission reception points at which the positioning measurements have started.

AA6. The method of embodiment AA4, further comprising transmitting a measurement abort message to each of the one or more transmission reception points to abort the positioning measurements that have failed.

AA7. The method of any of embodiments AA1-AA6, wherein the second message is received via non-device-associated signaling that is not associated with a specific communication device.

AA8. The method of any of embodiments AA1-AA7, wherein the second message is received over a non-device-associated signaling connection that is not associated with a specific communication device.

AA9. The method of any of embodiments AA1-AA8, wherein the second message is a MEASUREMENT FAILURE INDICATION message.

AA10. The method of any of embodiments AA1-AA9, wherein the second message is received as part of a failure indication procedure.

AA11. The method of embodiment AA10, wherein the failure indication procedure is applicable to multiple positioning procedures or is positioning procedure agnostic.

AA12. The method of any of embodiments AA1-AA11, wherein the second message includes a cause indicating a reason why the radio network node can no longer report positioning measurements to the location server.

AA13. The method of embodiment AA12, wherein the cause is a radio network layer cause.

AA14. The method of embodiment AA12, wherein the cause is:
a connection with a communication device has been terminated, has been lost, or has timed out; or
a communication device has lost coverage.

AA15. The method of embodiment AA12, wherein the cause is:
a context of a communication device has been released;
a context of a communication device has been released in association with a mobility of the communication device; or
a context of a communication device has been released in association with a release of the communication device.

AA16. The method of embodiment AA12, wherein the cause is:
failure by a communication device to send sounding resource signaling, SRS;
SRS is not or cannot be sent by a communication device; or
a communication device has stopped sending SRS.

AA17. The method of embodiment AA12, wherein the cause is a communication device being released, disappearing, or experiencing an error.

AA18. The method of any of embodiments AA1-AA17, further comprising, based on the second message, determining that the radio network node has terminated reporting of the positioning measurements to the location server.

AA19. The method of any of embodiments AA1-AA18, wherein the location server implements a location management function, LMF.

AA20. The method of any of embodiments AA1-AA19, wherein the radio network node is an NG-RAN node.

AA21. The method of any of embodiments AA1-AA20, wherein the second message is received via a New Radio, NR, Positioning Protocol, NRPPa.

AA22. The method of any of embodiments AA1-AA21, wherein the radio network node is a gNodeB.

AA23. The method of any of embodiments AA1-AA22, wherein the positioning information includes one or more of:
a sounding reference signal, SRS, configuration;
a System Frame Number, SFN, initialization time; or
a UE T TEG Association List.

AA24. The method of any of embodiments AA1-AA23, wherein the positioning information is information for:
configuring positioning of a communication device;
configuring positioning measurements for positioning of a communication device; and/or
configuring resources on which are to be performed positioning measurements for positioning of a communication device.

AA25. The method of any of embodiments AA1-AA24, further comprising, after receiving the first message, transmitting signaling to start positioning measurements in one or more transmission reception points, wherein the signaling indicates resources on which to perform the positioning measurements, and wherein the second message is received after transmitting the signaling.

AA1-AA25. The method of any of embodiments AA1-AA25, wherein the positioning measurements are multi-RTT positioning measurements.

AA. The method of any of the previous embodiments, further comprising:
providing user data; and
forwarding the user data to a host computer via the transmission to a base station.

### GROUP B EMBODIMENTS

B1. A method performed by a radio network node configured for use in a communication network, the method comprising:
transmitting, to a location server in the communication network, a first message that provides positioning information for a specific communication device; and
after transmitting the first message, transmitting, to the location server, a second message notifying the location server that the positioning information for the specific communication device is no longer valid and/or that the radio network node can no longer report any updates to the positioning information for the specific communication device.

B2. The method of embodiment B1, wherein the second message indicates that the positioning information for the specific communication device is no longer valid.

B3. The method of any of embodiments B1-B2, wherein the second message indicates the radio network node can no longer report any updates to the positioning information for the specific communication device.

B4. The method of any of embodiments B1-B3, wherein the first message is a POSITIONING INFORMATION RESPONSE message.

B5. The method of any of embodiments B1-B4, wherein the second message is transmitted via device-associated signaling that is associated with the specific communication device.

B6. The method of any of embodiments B1-B5, wherein the second message is transmitted over a device-associated signaling connection that is associated with the specific communication device.

B7. Reserved.

B8. Reserved.

B9. The method of any of embodiments B1-B8, wherein the second message is a POSITIONING INFORMATION FAILURE message or a POSITIONING INFORMATION FAILURE INDICATION message.

B10. The method of any of embodiments B1-B8, wherein the second message is transmitted as part of a Positioning Information Exchange class 2 failure indication procedure.

B11. The method of any of embodiments B1-B8, wherein the second message is a POSITIONING INFORMATION UPDATE message that lacks any update to the positioning information for the specific communication device.

B12 The method of any of embodiments B1-B8, wherein the second message is transmitted as part of a Positioning Information Update procedure.

B13. The method of any of embodiments B1-B12, wherein the second message includes one or more of:
a positioning protocol transaction identifier;
a location server device measurement identifier; or
a radio network node device measurement identifier.

B14. The method of any of embodiments B1-B13, wherein the second message includes a cause indicating a reason why the positioning information for the specific communication device is no longer valid and/or why the radio network node can no longer report any updates to the positioning information for the specific communication device.

B15. The method of embodiment B14, wherein the cause is a radio network layer cause.

B16. The method of embodiment B14, wherein the cause is:
a connection with the specific communication device has been terminated, has been lost, or has timed out; or
the specific communication device has lost coverage.

B17. The method of embodiment B14, wherein the cause is:
a context of the specific communication device has been released;
a context of the specific communication device has been released in association with a mobility of the specific communication device; or
a context of the specific communication device has been released in association with a release of the specific communication device.

B18. The method of embodiment B14, wherein the cause is:
failure by the specific communication device to send sounding resource signaling, SRS;
SRS is not or cannot be sent by the specific communication device; or
the specific communication device has stopped sending SRS.

B19. The method of embodiment B14, wherein the cause is the specific communication device being released, disappearing, or experiencing an error.

B20. The method of any of embodiments B1-B19, wherein the second message is received during ongoing positioning of the communication device.

B21. The method of any of embodiments B1-B20, further comprising, terminating reporting of any updates to the positioning information for the specific communication device.

B22. The method of any of embodiments B1-B21, further comprising determining that the positioning information for the specific communication device is invalid.

B23. The method of any of embodiments B1-B22, further comprising, after transmitting the second message:
receiving signaling that requests, commands, or triggers one or more transmission reception points associated with the radio network node to stop or abort one or more positioning measurements for the specific communication device; or
receiving signaling that requests, commands, or triggers termination or deactivation of positioning measurements in one or more transmission reception points at which positioning measurements have started for the specific communication device.

B24. The method of any of embodiments B1-B23, further comprising receiving signaling that requests, commands, or triggers the one or more transmission reception points to abort or deactivate the one or more positioning measurements for the specific communication device.

B25. The method of any of embodiments B1-B23, further comprising receiving signaling that requests, commands, or triggers the one or more transmission reception points to release or deactivate resources that have been allocated for positioning of the specific communication device.

B26. The method of any of embodiments B1-B25, further comprising receiving, from the locations server, a positioning information request message that requests the positioning information for the specific communication device, and wherein the first message is transmitted as a response to the positioning information request message.

B27. The method of any of embodiments B1-B26, wherein the positioning information is information for:
configuring positioning of the specific communication device;
configuring positioning measurements for positioning of the specific communication device; and/or
configuring resources on which are to be performed positioning measurements for positioning of the specific communication device.

B28. The method of any of embodiments B1-B27, wherein the positioning information includes one or more of:
a sounding reference signal, SRS, configuration for the specific communication device;
a System Frame Number, SFN, initialization time; or
a UE Tx timing error group, TEG, Association List.

B29. The method of any of embodiments B1-B28, wherein the location server implements a location management function, LMF.

B30. The method of any of embodiments B1-B29, wherein the radio network node is an NG-RAN node.

B31. The method of any of embodiments B1-B30, wherein the first and second messages are each received via a New Radio, NR, Positioning Protocol, NRPPa.

B32. The method of any of embodiments B1-B31, wherein the radio network node is a gNodeB.

B33. The method of any of embodiments B1-B32, further comprising, after transmitting the first message, receiving signaling to start positioning measurements in one or more transmission reception points, wherein the signaling indicates resources on which to perform the positioning measurements, and wherein the second message is transmitted after receiving the signaling.

BB1. A method performed by a radio network node configured for use in a communication network, the method comprising:
transmitting, to a location server in the communication network, a first message that indicates the radio network node is able to initiate positioning measurements; and
after transmitting the first message, transmitting, to the location server, a second message notifying the location server that the radio network node can no longer report the positioning measurements.

BB2. The method of embodiment BB1, wherein the second message includes a list of one or more transmission reception points for which the positioning measurements have failed.

BB3. Reserved.

BB4. Reserved.

BB5. The method of embodiment BB4, further comprising:
stopping or aborting the positioning measurements in one or more transmission reception points; or
terminating the positioning measurements in one or more transmission reception points at which the positioning measurements have started.

BB6. The method of embodiment BB4, further comprising receiving a measurement abort message to abort positioning measurements at each of one or more transmission reception points.

BB7. The method of any of embodiments BB1-BB6, wherein the second message is transmitted via non-device-associated signaling that is not associated with a specific communication device.

BB8. The method of any of embodiments BB1-BB7, wherein the second message is transmitted over a non-device-associated signaling connection that is not associated with a specific communication device.

BB9. The method of any of embodiments BB1-BB8, wherein the second message is a MEASUREMENT FAILURE INDICATION message.

BB10. The method of any of embodiments BB1-BB9, wherein the second message is transmitted as part of a failure indication procedure.

BB11. The method of embodiment BB10, wherein the failure indication procedure is applicable to multiple positioning procedures or is positioning procedure agnostic.

BB12. The method of any of embodiments BB1-BB11, wherein the second message includes a cause indicating a reason why the radio network node can no longer report positioning measurements to the location server.

BB13. The method of embodiment BB12, wherein the cause is a radio network layer cause.

BB14. The method of embodiment BB12, wherein the cause is:
a connection with a communication device has been terminated, has been lost, or has timed out; or
a communication device has lost coverage.

BB15. The method of embodiment BB12, wherein the cause is:
a context of a communication device has been released;
a context of a communication device has been released in association with a mobility of the communication device; or
a context of a communication device has been released in association with a release of the communication device.

BB16. The method of embodiment BB12, wherein the cause is:
failure by a communication device to send sounding resource signaling, SRS;
SRS is not or cannot be sent by a communication device; or
a communication device has stopped sending SRS.

BB17. The method of embodiment BB12, wherein the cause is a communication device being released, disappearing, or experiencing an error.

BB18. The method of any of embodiments BB1-BB17, further comprising terminating reporting of the positioning measurements to the location server.

BB19. The method of any of embodiments BB1-BB18, wherein the location server implements a location management function, LMF.

BB20. The method of any of embodiments BB1-BB19, wherein the radio network node is an NG-RAN node.

BB21 The method of any of embodiments BB1-BB20, wherein the second message is transmitted via a New Radio, NR, Positioning Protocol, NRPPa.

BB22. The method of any of embodiments BB1-BB21, wherein the radio network node is a gNodeB.

BB23. The method of any of embodiments BB1-BB22, wherein the positioning information includes one or more of:
a sounding reference signal, SRS, configuration;
a System Frame Number, SFN, initialization time; or
a UE T TEG Association List.

BB24. The method of any of embodiments BB1-BB23, wherein the positioning information is information for:
configuring positioning of a communication device;
configuring positioning measurements for positioning of a communication device; and/or
configuring resources on which are to be performed positioning measurements for positioning of a communication device.

BB25. The method of any of embodiments BB1-BB24, further comprising, after transmitting the first message, receiving signaling to start positioning measurements in one or more transmission reception points, wherein the signaling indicates resources on which to perform the positioning measurements, and wherein the second message is transmitted after transmitting the signaling.

BB1-BB25. The method of any of embodiments BB1-BB25, wherein the positioning measurements are multi-RTT positioning measurements.

BB. The method of any of the previous embodiments, further comprising:
obtaining user data; and
forwarding the user data to a host computer or a communication device.

### GROUP C EMBODIMENTS

C1. A location server configured to perform the method of any of the Group A embodiments.

C2. A location server comprising processing circuitry configured to perform the method of any of the Group A embodiments.

C3. A location server comprising:
communication circuitry; and
processing circuitry configured to perform the method of any of the Group A embodiments.

C4. A location server comprising:
processing circuitry configured to perform the method of any of the Group A embodiments; and
power supply circuitry configured to supply power to the location server.

C5. A location server comprising:
processing circuitry and memory, the memory containing instructions executable by the processing circuitry whereby the location server is configured to perform the method of any of the Group A embodiments.

C6. Reserved

C7. Reserved

C8. A computer program comprising instructions which, when executed by at least one processor of a location server, causes the location server to perform the method of any of the Group A embodiments.

C9. A carrier containing the computer program of embodiment C7, wherein the carrier is one of an electronic signal, optical signal, radio signal, or computer readable storage medium.

C10. A radio network node configured to perform the method of any of the Group B embodiments.

C11. A radio network node comprising processing circuitry configured to perform the method of any of the Group B embodiments.

C12. A radio network node comprising:
communication circuitry; and
processing circuitry configured to perform the method of any of the Group B embodiments.

C13. A radio network node comprising:
processing circuitry configured to perform the method of any of the Group B embodiments;
power supply circuitry configured to supply power to the radio network node.

C14. A radio network node comprising:
processing circuitry and memory, the memory containing instructions executable by the processing circuitry whereby the radio network node is configured to perform the method of any of the Group B embodiments.

C15. The radio network node of any of embodiments C10-C14, wherein the radio network node is a base station.

C16. A computer program comprising instructions which, when executed by at least one processor of a radio network node, causes the radio network node to perform the method of any of the Group B embodiments.

C17. The computer program of embodiment C16, wherein the radio network node is a base station.

C18. A carrier containing the computer program of any of embodiments C16-C17, wherein the carrier is one of an electronic signal, optical signal, radio signal, or computer readable storage medium.

1.-26. (canceled)

27. A method performed by a location server configured for use in a communication network, the method comprising:
receiving, from a radio network node, as part of a Positioning Information Update procedure, a message indicating that sounding reference signaling (SRS) transmission from a specific communication device has stopped.

28. The method of claim 27, further comprising, based on the message, determining that an SRS configuration previously received from the radio network node for the specific communication device is invalid and/or that reporting of any updates to an SRS configuration for the specific communication device has been terminated by the radio network node.

29. The method of claim 27, further comprising, based on the message:
transmitting signaling that requests, commands, or triggers one or more transmission reception points . . . 20-N) to stop or abort one or more positioning measurements for the specific communication device; or
transmitting signaling that requests, commands, or triggers termination or deactivation of positioning measurements in one or more transmission reception points at which positioning measurements have started for the specific communication device.

30. The method of claim 27, further comprising:
based on the message, determining one or more transmission reception points at which one or more positioning measurements have been started for the specific communication device and transmitting signaling that requests, commands, or triggers the one or more transmission reception points to abort or deactivate the one or more positioning measurements for the specific communication device; and/or
based on the message, determining one or more transmission reception points at which resources have been allocated for positioning of the specific communication device and transmitting signaling that requests, commands, or triggers the one or more transmission reception points to release or deactivate resources that have been allocated for positioning of the specific communication device.

31. The method of claim 27, wherein the message is a POSITIONING INFORMATION UPDATE message.

32. The method of claim 27, wherein the Positioning Information Update procedure is a procedure initiated by the radio network node to indicate to the location server that a change has occurred in an SRS configuration for the specific communication device, and wherein the message lacks any update to the SRS configuration for the specific communication device.

33. The method of claim 27, wherein the message is received:
via device-associated signaling that is associated with the specific communication device; or
over a device-associated signaling connection that is associated with the specific communication device.

34. The method of claim 27, further comprising determining the specific communication device for which the message is received, based on the specific communication device being associated with device-associated signaling or a device-associated signaling connection via which the message is received.

35. The method of claim 34, wherein determining the specific communication device is performed:
without searching, across multiple transmission reception points associated with the radio network node, for a match between an SRS configuration for a device context and an SRS configuration for a measurement context; or
without searching, across multiple transmission reception points associated with the radio network node, for a match between a measurement identifier in a device context and a measurement identifier in a measurement context.

36. The method of claim 27, wherein the location server implements a location management function (LMF), wherein the radio network node is a gNodeB, and wherein the message is received via a New Radio (NR) Positioning Protocol (NRPPa).

37. A method performed by a radio network node configured for use in a communication network, the method comprising:
transmitting, from the radio network node to a location server, as part of a Positioning Information Update procedure, a message indicating that sounding reference signaling (SRS) transmission from a specific communication device has stopped.

38. The method of claim 37, wherein the message is a POSITIONING INFORMATION UPDATE message.

39. The method of claim 37, wherein the Positioning Information Update procedure is a procedure initiated by the radio network node to indicate to the location server that a change has occurred in an SRS configuration for the specific communication device, and wherein the message lacks any update to the SRS configuration for the specific communication device.

40. The method of claim 37, wherein the message is transmitted:
via device-associated signaling that is associated with the specific communication device; or
over a device-associated signaling connection that is associated with the specific communication device.

41. The method of claim 37, wherein the location server implements a location management function (LMF) wherein the radio network node is a gNodeB, and wherein the message is transmitted via a New Radio (NR) Positioning Protocol (NRPPa).

42. A location server configured for use in a communication network, the location server comprising:
communication circuitry; and
processing circuitry configured to receive, from a radio network node, as part of a Positioning Information Update procedure, a message indicating that sounding reference signaling (SRS) transmission from a specific communication device has stopped.

43. A radio network node configured for use in a communication network, the radio network node comprising:
communication circuitry; and
processing circuitry configured to transmit, from the radio network node to a location server, as part of a Positioning Information Update procedure, a message indicating that sounding reference signaling (SRS) transmission from a specific communication device has stopped.

44. The radio network node of claim 43, wherein the Positioning Information Update procedure is a procedure initiated by the radio network node to indicate to the location server that a change has occurred in an SRS configuration for the specific communication device, and wherein the message lacks any update to the SRS configuration for the specific communication device.

45. The radio network node of claim 43, wherein the message is transmitted:
via device-associated signaling that is associated with the specific communication device; or
over a device-associated signaling connection that is associated with the specific communication device.

46. The radio network node of claim 43, wherein the location server implements a location management function (LMF), wherein the radio network node is a gNodeB, and wherein the message is transmitted via a New Radio (NR) Positioning Protocol (NRPPa).
